(19) United States
(12) Patent Application Publication
(10) Pub. No.: US 2026/0288937 A1
(43) Pub. Date: Sep. 24, 2026

(54) SYSTEM FOR IMPLEMENTING SOFTWARE-BASED TRUSTED EXECUTION ENVIRONMENT FOR EMBEDDED DEVICE AND METHOD THEREFOR

(71) Applicant: THE INDUSTRY & ACADEMIC COOPERATION IN CHUNGNAM NATIONAL UNIVERSITY (IAC), Daejeon (KR)

(72) Inventors: Jinsoo JANG, Daejeon (KR); Seungkyun HAN, Daejeon (KR)

(73) Assignee: THE INDUSTRY & ACADEMIC COOPERATION IN CHUNGNAM NATIONAL UNIVERSITY (IAC), Daejeon (KR)

(21) Appl. No.: 19/144,443

(22) PCT Filed: Dec. 8, 2023
(86) PCT No.: PCT/KR2023/020250

§ 371 Date: Jun. 27, 2025

(30) Foreign Application Priority Data
May 10, 2023 (KR) 10-2023-0060682

(51) Int. Cl. G06F 21/53

(52) U.S. Cl. CPC G06F 21/53; G06F 2221/033

(57) ABSTRACT

The present invention relates to a system for implementing a software-based trusted execution environment for an embedded device and, more particularly, to a system for implementing a software-based trusted execution environment for an embedded device to construct a trusted execution environment in the embedded device, and a method therefor. According to the present invention, it is possible to securely protect data in an embedded environment that does not have hardware support for constructing a trusted execution environment, and to achieve secure input/output for secure communication between hardware and a trusted execution environment.

### TECHNICAL FIELD

The present disclosure relates to a system for implementing a software-based trusted execution environment for an embedded device and, more specifically, to a system and a method for implementing a software-based trusted execution environment for an embedded device in order to construct a trusted execution environment in an embedded device.

### BACKGROUND ART

Low-specification embedded devices usually have limited processing performance and memory capacity. Because of these limited-hardware resources, it is difficult to implement security functions required to implement a trusted execution environment. For example, utilizing a hardware security module or key may ensure good security to implement a root of trust. However, because of the lack of such hardware resources, it is difficult to use this method in low-specification embedded devices.

A trusted execution environment (TEE) is one of reasonable security measures to protect security-critical services and data on embedded devices. In particular, when considering the high market share of ARM in mobile and embedded devices (90% for mobile, IoT, and in-vehicle systems), TrustZone, the security extension of the ARM processor, is the most powerful means for activating the TEE on embedded devices.

The TEE technology, such as ARM TrustZone, enables memory protection, secure communication channel establishment with peripheral devices, and the like. Despite the very useful technology, it has been utilized in a limited way, and this is because TEE implementations are generally confidential and disclosed only to contractors of the SoC development company so that it is not available for the third party to readily utilize. In addition, a low-specification device that is publicly available, such as RPI, may be missing hardware function essential for the TEE configuration.

Also, the deployment of TEE in actual working environments is limited for the following reasons. Embedded devices sometimes are incomplete in the implementation of the hardware components required to construct the TEE. For example, the Broadcom BCM2837 SoC, which is deployed in commercial devices such as a smart hub, does not support TrustZone extensions for memory and peripheral device isolation.

### RELATED ART DOCUMENTS

### Patent Document

Korean Patent Application Publication No. 2011-0037140 (Published on Apr. 13, 2011)

### DISCLOSURE

### Technical Problem

An objective of the present disclosure is to provide a system and method for implementing a software-based trusted execution environment for an embedded device in order to compensate for the absence of hardware supports (TZASC, TZPC) for constructing a trusted execution environment in a low-specification embedded device based on an ARM architecture.

### Technical Solution

The present disclosure includes a stage-2 paging unit for separating a software-based trusted execution environment (TEE) and a rich execution environment (REE) f an embedded device to independently manage a memory in each execution environment, a DMA filtering unit for filtering a DMA transaction that directly transmits data from an input/output (I/O) device to a memory in order to defend against a malicious DMA attack, a memory isolation and protection unit for isolating a TEE and REE, a hypervisor, and a security monitor, a temporary authority escalation/de-escalation unit for escalating or de-escalating a privilege in order to temporarily use a resource provided in the rich execution environment when performing security-related tasks in the trusted execution environment, and a security input/output unit for performing a logging and a verification of an input and output operation between the TEE and the REE.

The memory isolation and protection unit may compensate for an absence of a memory isolation hardware (TZASC) by achieving a memory isolation on the basis of a stage-2 paging of a virtualization technology.

In addition, the temporary authority escalation/de-escalation unit may compensate for an absence of a secure input/output hardware (TZPC) by reusing a device driver to temporarily escalating or de-escalating the privilege in a code block of an input/output operation.

Meanwhile, a method using a system for implementing a software-based trusted execution environment for an embedded device includes (a) separating a software-based trusted execution environment (TEE) and a rich execution environment (REE) of an embedded device to independently manage a memory in each execution environment by the system, (b) filtering a DMA transaction that directly transmits data from an input/output (I/O) device to a memory by the system, (c) isolating TEE and REE, a hypervisor, and a security monitor by the system, (d) escalating or de-escalating a privilege in order to temporarily use a resource provided in the rich execution environment when performing security-related tasks in the trusted execution environment by the system, and (e) performing logging and verification of an input and output operation between the TEE and the REE by the system.

### Advantageous Effects

According to the present disclosure, there are effects of safely protecting data and achieving a secure input/output for secure communication between hardware and a trusted execution environment in an embedded environment without hardware support for constructing a trusted execution environment.

### DESCRIPTION OF DRAWINGS

FIG. 1 is a view showing a framework of a system for implementing a software-based trusted execution environment for an embedded device according to an exemplary embodiment of the present disclosure.

FIG. 2 is a view showing a configuration of a system for implementing a software-based trusted execution environment for an embedded device according to an exemplary embodiment of the present disclosure.

FIG. 3 is a flowchart showing a method using a system for implementing a software-based trusted execution environment for an embedded device according to an exemplary embodiment of the present disclosure.

FIG. 4 is a view showing a communication process between an application and a peripheral device.

FIG. 5 is a view showing a physical memory layout and memory permission settings for protecting TEE and MyTEE components.

FIG. 6 is a view for describing that MyTEE verifies a DMA control block in order to prevent a malicious DMA from being triggered by an untrusted operating system.

FIG. 7 is a view for describing that MyTEE checks a CB setting in a DMA two-dimensional (TD) mode to ensure that DMA does not access a protected region on each data transmission iteration.

FIG. 8 is a view for describing that a temporal privilege escalation of a device driver partition and a combination of shared and stage-2 page tables enable secure IO without bloating TEE.

FIG. 9 is a view showing a listing 1 (an original function with write1 and a listing 2 (an instrumented function with MyTEE APIs).

FIG. 10 is a view showing a communication process for secure IO.

FIGS. 11a and 11b are views showing a result of executing LMBench and CoreMark-PRO.

FIG. 12 is a view showing a performance of a memory-to-memory data transmission in a DMA TD mode when CB is verified by MyTEE.

FIGS. 13a and 13b are views showing a performance (microseconds) of a hardware TPM for a random number generation and a hashing with SHA1 and SHA256.

### BEST MODE

The present disclosure is to compensate for the absence of hardware supports (TZASC, TZPC) for constructing a trusted execution environment in a low-specification embedded device based on an ARM architecture, and proposes a system for implementing a software-based trusted execution environment for an embedded device, which enables using TEE even in a worst-case condition where TEE essential hardware is not provided.

The core technology stack of MyTEE may include memory separation/isolation technology based on virtualization technology, IOMMU through MMIO filtering, and secure IO channel with peripheral devices.

MyTEE may be a solution for strengthening the trusted execution environment (TEE). It may be for protecting and strengthening the TEE in the environment without hardware support such as TrustZone, a hardware security function, through which a TEE platform such as OP-TEE, an open-source TEE platform, can be protected even in a limited environment. MyTEE may protect the TEE through memory protection, DMA attack prevention, secure IO, and the like. An active integrity monitor using stage-2 paging may be used for memory protection, and a DMA filter may be used to prevent DMA attacks. In addition, for secure IO, the pDrv and cDrv may be hardened using MyTEE APIs. These components of MyTEE may run in a monitor mode and a hypervisor mode, and may constitute a trusted computing base (TCB). Through this, the security of the TEE and MyTEE may be strengthened.

In particular, the system for implementing a software-based trusted execution environment for an embedded device according to the present exemplary embodiment may provide a MyTEE API for escalating a privilege of a part of the code of the device driver instead of protecting the entire code, and may enable forming a secure communication channel with peripheral devices while minimizing developers' direct modification of privileged software.

The prototype may demonstrate the feasibility of MyTEE by implementing it on an rpi board that does not support most of the TrustZone extensions. As an example software, the hardware TPM utilizing MyTEE, frame buffer, and USB keyboard protection technology may be implemented.

In terms of the usefulness of TEE technology, the TEE technology for enabling the protection of important services or data by configuring an additional trusted execution environment in a system may be one of the promising security technologies to alleviate such a problem. In particular, ARM TrustZone may be a security extension function of ARM processors mainly used in mobile/embedded devices. When TrustZone is activated, in addition to dividing the CPU state into secure/non-secure, the secure IO can be configured through a function that isolates the TEE region by hardware-based memory access control and enables direct communication between peripheral devices and TEE.

In an exemplary embodiment of the present disclosure, MyTEE may be proposed in order to compensate for the absence of hardware supports (TZASC, TZPC) for constructing a trusted execution environment in a low-specification embedded device based on an ARM architecture. The lowest-level device may be assumed that does not provide additional TrustZone functions other than dividing the CPU security state. That is, the memory protection through a TZASC (TrustZone Address Space Controller) or the safe communication with peripheral devices through a TZPC (TrustZone Protection Controller) may not be possible. In such an environment, the core of MyTEE may be a technology that provides TEE memory isolation, DMA attack defense, and a secure communication method with peripheral devices in order to increase the reliability and safety of TEE.

First of all, the memory protection may utilize a page table management-based method. First, direct access to the TEE from the REE may be controlled in a way of not generating the s2 mapping to the TEE region. In addition, in order to prevent TEE access by the hypervisor-privileged code that is not affected by s2 paging, the page table used by the hypervisor may be also managed in the TEE region. Not only the page table but also other key commands may be emulated in the TEE region. When utilizing a DMA (malicious direct memory access) engine, an attacker can write or read any region in an environment where IOMMU (Input/Output Memory Management Unit) or TZASC (TrustZone Address Space Controller) is not provided. That is, even the TEE region protected by s2 paging may be attackable. To prevent this, a filter may be configured to trap the MMIO request for the DMA engine with s2 and verify in advance. In order to safely communicate with peripheral devices, the requests to be delivered to peripheral devices may be delegated to the REE region. First, the buffer used for communication and the MMIO region of the controller may be protected by s2 paging. Also, the privilege of a part of the device driver code accessing thereto may be escalated to the hypervisor to operate normally. The result value generated by the peripheral device may be written to the protected buffer and this may be directly consumed by the TA. This method may have the advantage of not creating a new attack vector as not increasing the size of the TEE region.

In relation to the implementation of MyTEE, the RPI3 B+ board providing BCM2837 soc may be used as an implementation equipment. OP-TEE may be used as a TEE software, and Raspbian OS with Linux 4.15 version may be used for REE. OP-TEE may be an open-source software for implementing a trusted execution environment (TEE) by utilizing ARM TrustZone. OP-TEE can be used in various operating systems such as Android and Linux, and can operate on ARM-based processors such as the ARM Cortex-A series. OP-TEE may provide secure applications and kernel modules running in the TEE environment, safely protect data in the TEE environment, and provide secure authentication and encryption services.

Page table management and emulation for memory protection may be implemented with some functions of ARM TF. ARM TrustZone Firmware (TF) may be a program running on a TrustZone-enabled SoC (System-on-Chip) and may serve to maintain and manage the security and stability of TrustZone. A microhypervisor may be implemented to protect MMIO filters and peripheral devices. In particular, a hypervisor service call, such as the privilege escalation of the device driver, may be implemented in the form of MyTEE API to be inserted when implementing the driver. To demonstrate the practicality of MyTEE, three security applications may be implemented to ensure secure communication with peripheral devices: a hardware TPM, a framebuffer, and a USB keyboard. The MyTEE API may be embedded into the protocol controller (e.g., SPI and USB) used by each peripheral device and into the device driver of the peripheral device to protect the buffer used for communication and to enable proper execution through partial privilege escalation of codes accessing thereto.

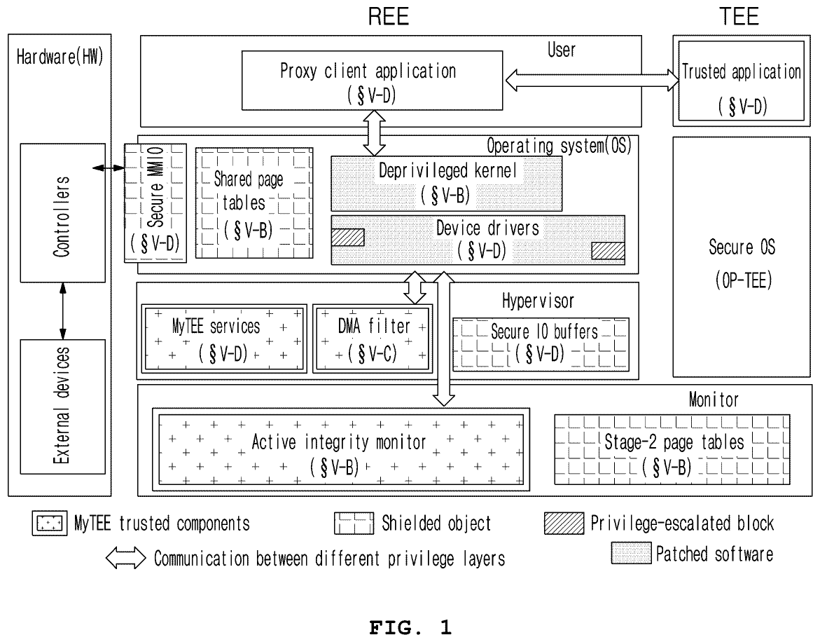

FIG. 1 is a view showing a framework of a system for implementing a software-based trusted execution environment for an embedded device according to an exemplary embodiment of the present disclosure.

As shown in FIG. 1, MyTEE may include an active integrity monitor for memory isolation, a DMA packet filter, and secure IO, and this may be a framework that can isolate and protect security-critical components on the basis of the stage-2 paging and DMA filtering implementation of the virtualization technology, and achieve the secure input/output by utilizing security buffers and operation log verification.

The system (MyTEE) for implementing a software-based trusted execution environment for an embedded device according to the present exemplary embodiment may aim to enable TEE in a strictly limited environment where hardware security extensions are not supported. That is, the open-source TEE platform such as OP-TEE can be protected by MyTEE even when deployed on such a limited environment. In order to support the memory protection without TZASC, the active integrity monitor may isolate memory by using stage-2 paging and may de-privilege the kernel (V-B). In addition, the DMA filter that monitors every MMIO transaction to the DMA controller may be designed to prevent DMA attacks (V-C). For secure IO, the pDrv and cDrv may be hardened using MyTEE APIs to shield the IO buffers and memory-mapped registers of the controller and to allow part of the device driver code to securely and seamlessly access thereto (V-D). In particular, MyTEE running in the hypervisor and monitor modes may constitute the trusted computing base (TCB). In particular, filtering DMA and supervising the critical operations may enable strict isolation of the trusted components from the untrusted OS. Additional trusted services such as secure IO may be built on the basis of the isolation.

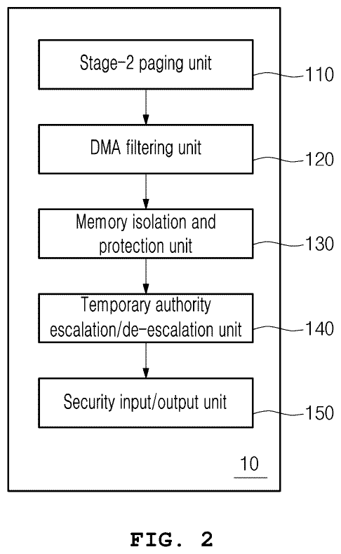

FIG. 2 is a view showing a configuration of a system for implementing a software-based trusted execution environment for an embedded device according to an exemplary embodiment of the present disclosure.

As shown in FIG. 2, the system 10 for implementing a software-based trusted execution environment for an embedded device according to the present exemplary embodiment may include a stage-2 paging unit 110, a DMA filtering unit 120, a memory isolation and protection unit 130, a temporary authority escalation/de-escalation unit 140, and a security input/output unit 150.

The stage-2 paging unit 110 may be configured to map a virtual address space into a physical memory space. Such a stage-2 paging unit 110 may be one of the virtualization technologies provided by an ARM architecture, and may enable isolating the TEE and the REE to independently manage memory in each execution environment. To this end, the stage-2 paging mechanism may be used to map the virtual address space to the physical memory space.

The stage-2 paging of the virtualization technology may be one of the virtualization technologies provided by ARM architecture and may be a mechanism of mapping the virtual address space into the physical memory space. In the virtualization technology, the hypervisor may map the virtual address space of a guest operating system into the physical memory space. However, in ARM architecture, the trusted execution environment (TEE) and the rich execution environment (REE) can be separated from each other through the TrustZone technology used with the hypervisor to independently manage memory in each execution environment.

In order to isolate the trusted execution environment (TEE) and the rich execution environment (REE), stage-2 paging of virtualization technology may maintain separate page table for each execution environment. This page table may be used to map the virtual address space to the physical memory space and to isolate memory access between the TEE and the REE.

The page tables of the TEE and the REE may be used in different privilege modes and may limit the physical memory space accessible in each execution environment. In ARM architecture, the TEE and the REE may run in each privilege mode. The TEE may run in a secure monitor mode, and the REE may run in a non-secure mode. Accordingly, the TEE and the REE may operate in different privilege modes. Such a privilege mode may also be called the protection mode of the ARM. Each protection mode may define a set of instructions that the CPU can execute and the restrictions on memory access permissions, and the instructions for switching between the protection modes may be also different from each other. The TEE may have restricted instructions and memory access permissions in order to maintain a secure environment, and the REE may have the same permissions as general applications.

In addition, using the page table, the memory protection function may be provided and the memory protection level may be configured.

Such a stage-2 paging of the virtualization technology may enable isolating the TEE and the REE to enhance security and independently managing memory in each execution environment.

That is, the TEE and the REE should be allocated different memory regions, and for this, stage-2 paging of the virtualization technology may be used. Each environment may have its own virtual address space, and this space may be mapped to the physical memory space. By doing this, the TEE and the REE may independently manage memory in different memory regions, and the code or data executed in the TEE may not affect other environments such as the REE or hypervisor.

The DMA filtering unit 120 may be configured to filter DMA transactions in order to defend against malicious DMA attacks. This may prevent the memory of the TEE from directly being accessed by the input/output (I/O) device of the REE.

Direct Memory Access (DMA) filtering may be a configuration to protect the system from malicious DMA attacks. DMA may be a technology that directly transmits data from an input/output (I/O) device to a memory and may be used to improve input/output performance. However, since DMA is not generally controlled by the CPU's supervision, malicious code may access memory and compromise system security.

In order to defend against these malicious DMA attacks, DMA filtering may inspect DMA transactions and may blocks unsafe transactions. DMA filtering may be implemented as a combination of hardware and software.

In terms of software, the DMA filtering driver may operate. This driver may monitor DMA transactions and may block DMA transactions not allowable according to filtering rules. The filtering rules may be variously set according to the security policy of the system, and may include rules for limiting DMA transactions between input/output (I/O) devices and memory.

In terms of hardware, IOMMU (Input-Output Memory Management Unit) may be used. The IOMMU may provide the function of mapping the physical address of memory to the virtual address in order to protect DMA transactions. This may limit the memory space that DMA can access and may block malicious DMA transactions.

Therefore, the DMA filtering may be an important security technique that protects the system from malicious DMA attacks while maintaining memory isolation of the TEE and the REE.

The memory isolation and protection unit 130 may isolate the TEE and the REE, the hypervisor, and the security monitor to achieve memory isolation/protection. This may prevent security-related tasks running in the TEE from affecting other environments such as the REE or hypervisor.

The memory isolation and protection unit according to the present exemplary embodiment may achieve the memory isolation on the basis of the stage-2 paging of the virtualization technology and compensate for the absence of the memory isolation hardware (TZASC).

The TEE and the REE should be allocated different memory regions, and for this, the code or data executed on the TEE may not affect other environments such as the REE or hypervisor through the stage-2 paging of the virtualization technology. In addition, the security monitor may control memory access between the TEE and the REE to prevent the code or data running on the TEE from invading the memory of the REE. The hypervisor may host multiple virtual machines and may protect against other environments by isolating various operating systems and applications simultaneously running on each virtual machine.

This configuration of the memory isolation and protection unit may be an important factor in enhancing the security of the system and may ensure that the code or data performing security-critical tasks executed on the TEE is protected from the outside.

The memory isolation and protection function may be implemented using the stage-2 paging of the virtualization technology. This may isolate the virtual address space of the application, restrict memory access permissions, and support memory encryption when necessary. These functions may compensate for the absence of the TrustZone Address Space Controller (TZASC), a hardware-based memory isolation system. That is, the memory isolation and protection unit may use the virtualization technology to achieve the memory isolation in a software manner. This can replace existing hardware-based memory isolation systems and provide a high level of security.

Memory isolation hardware (TZASC) may be a memory protection function provided by the existing ARM TrustZone architecture and may control having access to physical memory addresses. This memory protection function may be very important for operating a secure system from memory attacks. However, many devices that are not provided with TZASC may use a memory isolation technology to achieve the memory protection. The memory isolation technology may create an isolated environment, such as processes or containers, and enable not interfering with each other. MyTEE may use the memory isolation technology to isolate the memory space of the application and the protection unit. For this, the stage-2 paging may be used to separate the virtual address space of the protection unit and the application. In this way, the application cannot directly access the memory space of the protection unit. Instead, the MyTEE may provide an interface necessary to access and execute the memory of the memory isolation and protection unit.

That is, MyTEE may enable achieving the memory isolation and protection even in the devices without the memory isolation hardware (TZASC). This may ensure safer and more reliable system operation.

The temporary authority escalation/de-escalation unit 140 may allow the temporary privilege escalation to be performed in the REE when necessary when performing security-related tasks in the TEE. In addition, when the task is finished, it is possible to lower the privilege back to the TEE.

The temporary authority escalation/de-escalation unit according to the present exemplary embodiment may compensate for the absence of the secure input/output hardware (TZPC) with the temporary privilege escalation of the input/output operation code block by reusing the device driver.

When resources provided by the REE are required for security-related tasks executed in the TEE, the temporary authority escalation/de-escalation unit may perform temporarily the privilege escalation in the REE to allow accessing the corresponding resources. This may allow the TEE to run in its own securely isolated environment, and can access the resources provided by the REE when necessary.

Usually, the TEE and the REE may run in different privilege modes, and the TEE may run in a minimal privilege mode. Therefore, the TEE cannot directly access the resources provided by the REE when handling security-related tasks. At this time, when using the temporary authority escalation/de-escalation unit provided by the REE, the TEE may temporarily use the resource provided by the REE even in a securely isolated state.

For example, the TEE may store encrypted data by using a securely isolated storage, and the REE may store files by using a file system. At this time, when the encrypted data in the TEE needs to be stored in the file system, the TEE cannot directly access the file system resources provided by the REE. At this time, when using the temporary authority escalation/de-escalation unit provided by the REE, the TEE can temporarily access the file system resources provided by the REE to store the encrypted data. When the task is finished, the privilege may be lowered back to the TEE, and this temporary authority escalation/de-escalation unit may allow the TEE and the REE to share necessary resources while maintaining a securely isolated state.

The secure input/output hardware (TZPC) may protect input/output by preventing the user region code from using the input/output port directly. However, in some scenarios, the user region code may have to use the input/output port directly. To this end, the temporary authority escalation/de-escalation unit may compensate for the absence of the secure input/output hardware (TZPC) with the temporary privilege escalation/de-escalation of the input/output operation code block by reusing the device driver.

That is, the use of the temporary privilege escalation/de-escalation may allow the user region code to access and use the input/output port, but this may be the temporary privilege escalation/de-escalation only possible in a short period of time, so that security is maintained. Through this, it is possible to compensate for the absence of the secure input/output hardware (TZPC) and protect secure input/output.

Secure input/output hardware (TZPC) can generally operate only in a trusted environment and may be a function not supported by a general operating system. Therefore, MyTEE may achieve the temporary privilege escalation/de-escalation of the input/output operation code block by using a reusable device driver in order to support secure input/output even in a general operating system environment.

For temporary privilege escalation/de-escalation, MyTEE may provide a new device driver implemented as a Linux kernel module. This driver may process secure input/output in the kernel, and may perform the temporary privilege escalation/de-escalation task. This driver may be loaded into kernel memory and may utilize the memory isolation and protection function of the MyTEE in order to protect the secure input/output buffer.

This driver can deliver the result of the request processed by MyTEE to the user space and the data can be transferred from the user space through the driver. This may mean to compensate for the absence of the secure input/output hardware (TZPC) while ensuring secure data transfer between MyTEE internals and the general operating system through the temporary privilege escalation/de-escalation.

The security input/output unit 150 may be a secure I/O technology, and may allow to safely perform input/output operations between the TEE and the REE by utilizing the input/output hardware operation logging and log verification technology. Through this, the access to the input/output device of the REE may be protected in the TEE.

The security input/output unit 150 may be a configuration for safely performing input/output operations between the TEE and the REE. This configuration may use secure I/O technology to perform logging and verification of input and output operations. Through this, the TEE may not allow direct access to the input/output devices of the REE, and may process input/output operations requested from the REE through the security input/output unit. By doing this, the TEE may perform a security-related task independent of the REE, and may be safely protected from the security threat generated in the REE.

In addition, the security input/output unit may perform the security verification on the input and output data. This may be done by checking the integrity of the input and output data, and by checking whether there is an attempt to forge or falsify it. Only the data verified in this way may be processed in the TEE.

Therefore, the security input/output unit may safely handle input/output operations between the TEE and the REE and may serve to enhance security.

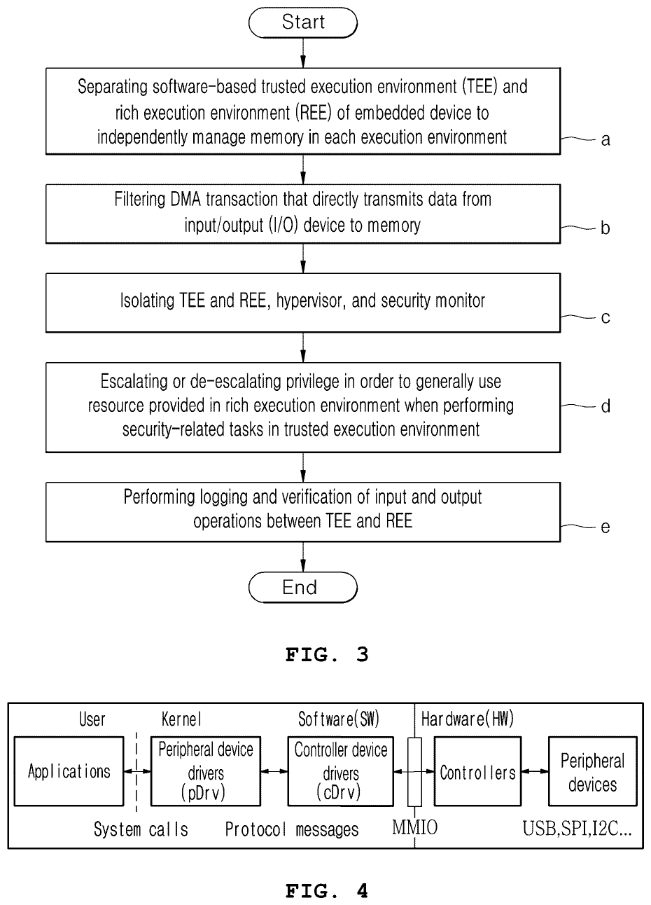

FIG. 3 is a flowchart showing a method using a system for implementing a software-based trusted execution environment for an embedded device according to an exemplary embodiment of the present disclosure.

As shown in FIG. 3, a method using the system for implementing a software-based trusted execution environment for an embedded device (hereinafter referred to as the system) may include (a) independently managing memory in each execution environment by the system separating the software-based trusted execution environment (TEE) and the rich execution environment (REE) for an embedded device through the stage-2 paging unit, (b) filtering by the system the DMA transactions that directly transfer data from an input/output (I/O) device to memory through a DMA filtering unit, (c) isolating the TEE and the REE, the hypervisor, and the security monitor through the memory isolation and protection unit by the system, (d) performing the privilege escalation or privilege de-escalation through the temporary authority escalation/de-escalation unit by the system so that the resources provided in the rich execution environment can be temporarily used when performing security-related tasks in the trusted execution environment, and (e) performing logging and verification of input and output operations between the TEE and the REE through the security input/output unit by the system.

Hereinafter, the system for implementing a software-based trusted execution environment for an embedded device according to the present exemplary embodiment will be described.

The system for implementing a software-based trusted execution environment for an embedded device according to the present exemplary embodiment may propose a method for safely configuring the TEE while assuming the worst scenario where hardware functions utilized for configuring the TEE are minimally supported. In addition, in order to avoid bloating the TEE, the secure IO may be implemented by reusing device drivers. In addition, a kernel API that can be easily used by device driver developers may be provided in consideration of usability.

Herein, the bloating may refer to making the system inefficient in various aspects including its size, because of the presence of unnecessary or overlapping codes or functions. Since TEE should operate with limited memory and resources, a small and lightweight configuration may be ideal. Accordingly, when bloating occurs, it can have a negative impact on the performance and stability of the TEE. Therefore, in order to avoid bloating the TEE, necessary functions may be implemented by reusing the already implemented device drivers, and unnecessary functions may be removed in order to maintain a lightweight configuration.

In the system for implementing a software-based trusted execution environment for an embedded device in order to compensate for the absence of the hardware supports (TZASC, TZPC) for constructing the trusted execution environment in a low-specification embedded device based on an ARM architecture, a detailed description may be that the rich execution environment (REE), the trusted execution environment (TEE), the hypervisor, and the security monitor are isolated to achieve the memory isolation/protection by utilizing the stage-2 paging of the virtualization technology provided by ARM architecture and by implementing the DMA filter to defend against malicious DMA attacks. In addition, the secure input/output may be achieved by utilizing a technique of the temporary privilege escalation/de-escalation and a technique of the logging and log verification of the input/output hardware operation. Based on this, the memory isolation may be achieved on the basis of the stage-2 paging of the virtualization technology, thereby compensate foring the absence of the memory isolation hardware (TZASC).

In the present exemplary embodiment, ARMv8, a 64-bit ARM architecture used in an ARM development board, will be described as an example.

### Security States

In devices with TrustZone enabled as a security extension function, the security state may be divided into two states: secure and non-secure. The non-secure state may be used to configure the rich execution environment and may be divided into user, kernel, and hypervisor privileges. The user mode may have the lowest privilege, and the hypervisor mode may have the highest privilege, and the entry from the low privilege to the high privilege may be possible by executing a special command. For example, the entry from the user mode to the kernel mode may be possible with svc and the entry from the kernel mode to the hypervisor mode may be possible through hvc. The secure state may be used to configure a high-security execution environment such as the trusted execution environment. Before ARMv8.4, user, kernel, and monitor modes may be provided, and from version 8.4, the hypervisor mode may be also provided in the secure state.

The monitor mode with the highest privilege in the system may be a special mode for transitioning between secure and non-secure states and mainly serve to store contextual information of the environment running in each state. Entry into the monitor mode may be possible to enter synchronously by utilizing smc.

The monitor and hypervisor mode may be mainly used to implement security technologies. To ensure the integrity of the kernel, the code and data of the kernel may be mapped with RO, and the page table may be mapped with RO as well. Also, the update of the page table or the base registers may be forced to be controlled in the monitor. In a 64-bit environment, a similar approach may be implemented by utilizing the hypervisor mode. The hypervisor may be utilized for implementing many security applications since it is possible to override the memory attributes of low-privileged software by utilizing the nested paging or to trap privileged instructions.

In addition to the security state, the following TrustZone hardware components may be defined to enable the implementation of various security applications. TZASC or TZMA may be used to partition the physical memory of DRAM or SRAM and may perform access control in hardware. For example, the memory allocated to the TEE can be forced to be accessible only when in the secure state. In addition, TZPC can be used to implement a specific device to dynamically have a secure/non-secure state.

This can ensure that a particular peripheral-device (e.g. keypad) is dedicated to use in the TEE.

Unlike the preceding security state, these functions may be a selective function, and whether to be applied may depend on the SoC.

### Execution States

ARMv8 may support both 32/64-bit architectures. Herein, there is a condition for determining the execution state according to the privilege of the mode, and the execution state of the lower privilege should be the same or lower than the execution state of the higher privilege. For example, when the monitor mode is implemented in 32 bits, all hypervisor or kernel above may be implemented in 32 bits. When the hypervisor is 64 bits, the kernel may have a 32 or 64 bit execution state. In addition, a 32-bit environment may support two page-table formats. When using the 4-byte short-descriptor format, it is possible to convert a 32-bit virtual address, and when using an 8-byte long-descriptor format, it is possible to convert up to 40 bits.

The hypervisor memory region and the nested paging may use only the long-descriptor format. On the other hand, the kernel and the user mode can use both formats.

Communication with Peripherals

The peripheral device can communicate with the host computer using a variety of protocols, such as Serial Peripheral Interface (SPI), Inter-Integrated Circuit (I2C), Peripheral Component Interconnect (PCI), and Universal Serial Bus (USB). The controller of each protocol may perform operations to manage the communication, such as assigning a device address, selecting a channel for communication, and initiating transactions. These operations may be performed by setting memory-mapped controller registers.

pDrv and cDrv may be two sub-drivers for managing peripheral devices and controllers among the components of a device driver. The pDrv (Peripheral Driver) may be a driver for controlling a peripheral device connected to the system. A peripheral device may be an external device connected to the system, and may correspond to a mouse, a keyboard, a display, a network interface card, and the like, for example. The pDrv may provide an interface between these peripheral devices and the kernel and may manage interactions between hardware and software of the corresponding device.

The cDrv (Controller Driver) may be a driver for managing hardware controllers for controlling peripheral devices. A controller may be a device that acts as a bridge between hardware and software, and may correspond to, for example, a disk controller, a network controller, a USB controller, and the like. The cDrv may manage the interactions among these controllers, hardware, and software, and through this may enable efficient control of peripheral devices. Therefore, the pDrv may be a driver for managing the interface between the peripheral device and the kernel and for managing the interactions between hardware and software of the corresponding device, and the cDrv may be a driver for managing hardware controllers for controlling peripheral devices and for managing the interactions between hardware and software.

A user process may interact with the device driver to communicate with the peripheral device. A controller driver (cDrv) and a peripheral driver (pDrv) may participate in communication. The pDrv may provide interfaces such as ioctl, write, and read to interact with the user process, and also may generate a protocol (e.g., USB) message for transmitting necessary information such as IO buffers and addresses of peripheral devices. The cDrv may retrieve information from the message and may configure the controller through MMIO. In addition, data may be read from the IO buffer and delivered to the peripheral device connected to the controller. The response from the peripheral device may also be read and written in the buffer. Such a memory operation may be performed through DMA in order to minimize the CPU burden. For example, the cDrv for an SPI controller may set the DMA controller such that the source and target may be set to the buffer and the SPI FIFO register respectively. FIG. 4 is a view showing a communication process between an application and a peripheral device.

Embedded devices may be actively used in various fields such as IoT and FL, but the hardware-based security functions mentioned above may be provided in a limited manner or not provided at all.

Table 1 below may show whether TEE-related hardware functions and SMMU functions are included in frequently used embedded boards based on ARMv8. Herein, SMMU may stand for System MMU and may be a device for mapping virtual addresses to physical addresses in ARM architecture-based systems. SMMU may serve to enhance system security, such as filtering access to specific devices or memory in a virtualized environment and managing securely isolated regions. SMMU may be also referred to as IOMMU and may play a key role in performing virtual address mapping function for input/output devices and strengthening the memory isolation of the TEE and the REE. SMMUv3 may be the latest version in ARMv8 architecture-based systems.

TABLE 1

| | TZASC | TZPC | TZMA | SMMU | SoC |
|---|---|---|---|---|---|
| Raspberry | x | x | x | x | Broadcom BCM2837 |
| Pi3 | | | | | |
| Hikye960 | v | v | x | v | Kirin 960 |
| Google | v | v | v | v | NXP i.MX 8M |
| coral | | | | | |
| Juno | O | x | x | O | ARM reference |
| | | | | partial | Amlogic s905 |

Basically, the SoC manual, Linux, and the source code of the open source TEE platform (OP-TEE) may be investigated. x may indicate that the corresponding hardware function is not provided, and O may indicate that it exists and its usage is disclosed in the source code or manual. v may indicate that the board's manual does not specifically state whether it exists, but a similar function exists in the specifications or source codes. For example, OCRAM in the coral board may be a function for dividing SRAM into secure/non-secure, and may be assumed to be similar to the TZMA function. In the case of TZASC of hikey960, it can be seen that the TZASC is supported through the presence of the hikey960_tzc_init function of the trusted firmware. However, only the newly defined register and hard-coded value by hisilicon may be known, not the register defined in the TZASC's specification. The specifications of hardware security functions required to implement the TEE may be accessible only to the contractors of the SoC manufacturer. In addition, the corresponding functions may be controlled by the TEE software such as QSEE, Tgris, and Knibi provided by the manufacturer.

Such system software may be locked with a hardware-embedded key and a secure boot. Therefore, the embedded service provider can only deploy user-level trusted applications and may need the verification and consent from the manufacturer to insert desired functions for system-level changes. These problems may act as obstacles in meeting the time-to-market requirement and ultimately lead to factors that hinder the use of the TEE. To solve the problem, the main purpose of the present disclosure may be to reduce the TEE dependency of device manufacturers and the dependency of hardware TEE features (TZASC, TZPC, SMMU). Specifically, the TEE of a 3rd party may be configured with only the open TEE software (OP-TEE) and the minimal hardware features and the advantages may be maximized.

For the Attack Model and Assumption, it may follow the general TEE attack model. That is, the OS may be untrusted. Therefore, the untrusted OS may attempt to access and manipulate kernel code or data. It is also possible to freely deliver a request to hardware devices such as DMA controllers. In this case, there is no TrustZone extension hardware function such as TZASC that can protect the TEE, and only CPU-based security state may be supported. Accordingly, even when the TEE software such the OP-TEE is installed, free access to the TEE memory may be allowable (citation: optee-rpi). On the other hand, the secure boot may be assumed as a base line defense, so it is not possible to tamper with firmware, a bootloader, a kernel image, and the like.

The usual secure boot may be based on trusting the root key inserted into the hardware and verify the integrity of the images loaded at boot time. However, this method may not be possible in environments where the TEE-related hardware is not provided, such as rpi. Fortunately, an sdcard-based secure boot method may be possible. That is, the region where the image is flushed on the sdcard may be forced to be immutable. In addition, it is assumed that the host device and the peripheral devices installed therein are reliable and physically isolated.

Therefore, malicious hardware attacks, sdcard changes, cold boot attacks, and the like may not be considered. In addition, side-channel attacks such as cache and prediction execution may be excluded from the consideration of the present disclosure.

For system design, the present exemplary embodiment may propose a method for utilizing the TEE function in an environment where a hardware security function is not provided or is limited. Presented is a method for reinforcing missing hardware functions based on RPI3 that provides the most outdated functions. That is, MyTEE may be added to the disclosed OP-TEE to ensure the intended security of the TEE and to be flexibly applicable. The s2 paging of the hypervisor and the deprivileging kernel technology may be utilized in order to emulate the TZASC function that protects the TEE memory.

In addition, the MMIO monitoring-based DMA filter may be configured to defend against attacks exploiting DMA on the TEE region and MyTEE in an environment where TZASC and SMMU are missing. A method of protecting the device drivers of hypervisor-based peripheral devices and controllers may be presented in order to realize the secure IO utilizing TZPC. At this time, rather than protecting the entire device driver, the buffer delivered to the device, and the memory-mapped registers of the controller may be protected with s2, and the region protected with s2 may be accessible by partially escalating the privilege of a part of the accessing driver code. In addition, it is possible to perform IO without malicious kernel intervention by allowing the application running on the TEE to perform read/write directly to the protected buffer. The privilege escalation and protection may have the advantage of enabling the insertion of MyTEE's API when implementing Linux device drivers and minimizing the hypervisor implementation.

For execution environment separation and isolation, the isolation for the TEE region can no longer be guaranteed due to missing TZASC. To complement this problem, traditional virtualization-based memory separation may be performed.

Basically, MyTEE may define three regions (TEE, hypervisor, normal OS). The TEE may be the region where the TEE software such as OP-TEE is present. A handler for handling some of the hypercalls defined in MyTEE may be defined in the hypervisor region. In addition, MyTEE may allow some of the kernel code to be escalated to the hypervisor privilege and to be executed, and the stack memory and data regions used in this process may be also defined as the hypervisor region. In particular, for the privilege escalation of the OS kernel code, the hypervisor may use the same page table as the OS kernel. This may allow the kernel-defined API (memcpy) to be executable by changing the current CPU mode to the hypervisor without a separate hypervisor mapping change.

This method may enable the kernel to access the hypervisor region or the TEE by modifying the page table, and in order to prevent this, memory permissions may be configured.

First, the page table of the kernel may map all regions except the TEE. At this time, the hypervisor code region may have execution permission, and the stack and data region may have RW permission, so that the code with the escalated privilege can access or execute data in see memory. Also, the s2 page table may be set at boot time so that the hypervisor region and the TEE region are set to be inaccessible from the normal OS. This may prevent the normal OS from directly accessing the hypervisor or TEE to perform an attack.

However, when the code performed through the privilege escalation is compromised, an access to the TEE may be attempted by modifying the OS page table. This may be because the hardware access control to the physical region is not possible due to the absence of TZASC and thus the hypervisor can access the TEE region through the page table manipulation. To prevent this attack, a method such as TZRKP may be used.

That is, the kernel page table itself may be set to RO, and the commands for updating the page table and the base register may be patched with SMC to be updatable after the verification in the TEE region. This may enable the hypervisor using the same page table as the OS to be immutable.

In addition, since there is no command that can change the base register in the code running with the hypervisor privilege, it is not possible to use malicious page tables. One possibility may be to tamper with the execution flow of the code running with the hypervisor privilege. However, such attacks can also be easily prevented. This is because the privilege escalation occurs only in very simple codes such as memcpy and is easily verifiable. In addition, address verification may be performed before performing memcpy, thereby preventing reading/writing to arbitrary memory.

In relation to the DMA Filter, the description may be as follows.

It may be critical to properly defend against attacks exploiting DMA in the MyTEE design. The reason may be that since there is no hardware-based memory access control function like TZASC, an attacker can use the DMA controller to tamper with MyTEE API calls patched in the TEE, hypervisor region, and kernel. DMA attacks can be broadly divided into two cases depending on where to be triggered.

The first attack may be the case when a malicious hardware device performs memory manipulation through a DMA request. However, in this case, the presence of malicious hardware may not be considered because it is excluded from the assumption. The second case may be the case when the malicious kernel requests read/write for a specific memory region through DMA. This may be possible by manipulating the source address, target address, and length value of the request packet delivered to the DMA controller. Therefore, the packet delivered from the kernel to the DMA controller should be properly monitored.

The packet delivered to the DMA controller may be performed by transferring the structure address of the packet through MMIO. To monitor this, the region where the register of the DMA controller is mapped may be made read-only with s2 paging, and whenever the kernel attempts to write to the corresponding register, an s2 page fault may be generated to perform DMA after the verification by the handler of the hypervisor region. The verification may determine whether the region adding the source address, the target address, and the length value to each belongs to the kernel code and data, the TEE region, the hypervisor's exception handler and data region, and the monitored MMIO region of the DMA controller, and the emulation may be performed when there is no problem. To prevent race conditions that occur between the verification and the emulation, the packet may be searched for by dereferencing an address value written to the controller, and may be copied as a shadow packet of the hypervisor region in advance. In addition, the case where DMA occurs to a protected buffer may be considered even though it is not applicable to the application. For example, when the source or target is a protected buffer region, the target or source address should be a protected buffer. This is to prevent an attacker from leaking secret values written by normal devices or manipulating the value to a value known to the attacker (random values generated by TPM).

In addition to the independent DMA controller, the USB controller may have its own DMA engine. In this case, unlike the preceding DMA controller, the DMA packet may have only one source or target address. For example, a value inputted to a USB keyboard may be read from the FIFO of the USB controller and the DMA may be performed to a buffer set in the packet. This case should also be monitored because it is possible to write to an arbitrary region even when the attacker cannot completely control the source data. Therefore, a region of the register for setting the DMA engine of the USB controller may be also set to s2 RO for monitoring. The monitoring rule may be the same as the preceding general DMA controller except for the rule for the protected buffer. The DMA for protected buffers may not be allowed except in special cases. For example, when protecting keyboard input, the key input information transmitted from the keyboard may be allowed only to be DMA-written to the protected buffer.

With regard to peripheral isolation, TZPC may be used to establish a secure channel between peripheral devices and the TEE. However, since there is no TZPC in low-specification devices, it is not possible to implement a secure peripheral device using such hardware function. In the present exemplary embodiment, a method for allowing the MyTEE to achieve the peripheral isolation to make it safe for TA to use will be discussed. Herein, TA may stand for trusted applications, and may mean a securely executed application. It may run on the TEE and operate in a securely protected memory region. Through the interface between the TEE and the REE, the TA may be execute in the REE and the data may be transmitted to the TEE.

In relation to design primitives for secure peripheral device, previously, TZPC may be used to set peripheral devices to the secure state and to implement device drivers within the TEE to dedicate peripheral devices. However, this method cannot be used in an environment having no hardware configuration such as TZPC and TZASC, and may have the disadvantage of increasing the potential vulnerability of the TEE by implementing drivers in the TEE.

MyTEE according to the present exemplary embodiment may solve this problem and may enable safely using the peripheral devices even when the peripheral devices are shared with the REE. The peripheral device protection of MyTEE may be based on the following design philosophy: The system should (1) not introduce a new attack surface to the TEE, (2) be flexible and easy to deploy, (3) provide precise operation as expected (4) not be abused (priv up/down).

For (1), instead of implementing a kernel driver in the TEE, the kernel driver of the OS may be reused. For this, the CA may be used as a proxy to deliver the request from the TA to the kernel driver. The kernel driver can be organized into pDrv and cDrv as already described. The pDrv may receive a user request and generate the request data. The cDrv may protect both drivers by transmitting the request to hardware through MMIO. When all are protected at this time, there is a high possibility of vulnerabilities and there are many things to consider in terms of security (in particular, verification is not possible due to the problem of protecting all kernel APIs). Therefore, we may protect only a part of the device drivers, not all of them. That is, the MMIO execution region for the cDrv setting and the input/output buffer of the pDrv may be selectively protected. In this case, the level of protection for the confidentiality or integrity of the buffer may vary depending on the peripheral devices and scenario.

For example, when printing medical data on the display by using fb, both confidentiality and integrity may be important. When requesting the TPM to generate a random value, the confidentiality of the TPM command in the buffer may not be important. It is only necessary to confirm that a normal value is transmitted.

In order to protect the integrity and confidentiality of the buffer, a shadow buffer in the memory region protected by s2 may be used. The MMIO region of cDrv may be also forced to be inaccessible using S2. Accordingly, it is not possible to access the buffer or perform MMIO in the general kernel. Therefore, the existing buffer access/MMIO execution code may be temporarily escalated and executed to the hypervisor privilege.

For this, priv up/down APIs that developers can use may be provided. The corresponding API may serve to call the hypervisor, allocate a new stack in the hypervisor, deactivate the interrupt, check where to be invoked (to prevent abuse), and return directly to the hypervisor's privilege. The code after priv up may be performed with the hypervisor privilege. Inaccessible regions may be accessible. After the completion of the operation, it may be performed with priv down. The opposite operation of up may be performed. The input data may be written directly to the region mapped to the hypervisor in TA, and the output data may be read directly by TA.

For (2) may be satisfied in partially increasing the privilege of the kernel code. That is, the verification/protection logic should be implemented with the hypervisor code in the traditional trap & emulate method. This may not be easy when considering that the device driver is implemented by the 3rd party. This may be solved by enabling a part of the kernel driver to be performed with the hypervisor privilege. Developers can directly implement and insert the MyTEE API or verification logic generated by us into the existing kernel driver logic.

For (3), the peripheral devices may perform the user request exactly. This may require the protection of the request data transmitted to the peripheral device and may be difficult in reusing the kernel driver.

For example, when the hypervisor call instrumented to the kernel code is not executed, the MMIO region may not be protected. In addition, even when protected, an attacker can put a malicious value in the code executed in a priv up/down block since there is a priv up/down code, thereby resulting in unintended consequences. This may be like a race condition, and for example, in the case of TPM, the TA may request a random value and the corresponding request may be transmitted to MMIO. However, before TA reads the value, the attacker can make another request and induce the TPM to generate a value that the attacker knows. For example, by generating a hash value, as a result, the TA may perform an operation using the value the attacker knows. In order to prevent these attacks, the logging and verification APIs may be utilized. By defining a sequence, the protection of buffer and MMIO region may be always preceded and may be logged. Then, logging for the request data may be performed. The TA may perform verification before use.

For (4), in addition to the logging, the verification logic may be performed. The expected attack may to manipulate or exploit the value executed in priv up. When thinking of mmio write, it is possible to attack the TEE or hyp region by manipulating the target address value. In order to prevent this, the value used for mmio write may be first copied to the hypervisor stack and then verified. Through copying parameters to a protected region, it is possible to defend against TOCTOU attacks that change values after the verification. Whether the dest region belongs to the corresponding region may be verified by including a context for the cDrv in the verification logic. This may be possible because the MMIO region address of the controller is determined at the time of soc design. In addition, as already mentioned, priv_up, and down may be forced to be callable only from the compiled code. Therefore, kernel drivers should be built statically into the kernel and cannot be used in dynamically loaded drivers.

In consideration of (1)-(4), the existing write1 function may be placed in a new wrapper function by using MyTEE to write to the mailbox controller for sending and receiving messages with the GPU, and whether the mmio target address is located in the register region of the mailbox controller may be verified. After that, the command to be transmitted to the mailbox may be logged and then write1 may be performed. The wrapper function may be called between priv_up and down and may be executed with the escalated privilege.

In addition, since mytee_priv_up resets the current stack pointer to a memory that is not accessible from the kernel, local variables (ret) used in the wrapper can be protected. In this example, the 32-bit parameters transmitted to the wrapper may be the values themselves and may not require a separate copy operation. However, when transmitted as an address value, an additional operation may be required for dereferencing the corresponding address and copying into the protected stack before the verification. In addition, the mmio address region of the example code may be protected as a region inaccessible in the kernel by a mytee_controller_lock API call inserted into the pDrv. The corresponding API call may be skipped by the attacker, but may be detectable by TA due to the logging missing.

```
  static int bcm2835_send_data(struct mbox_chan *link, void
*data) {
  ...
  write1(msg, mbox−>regs + MAIL1_WRT);
  ...
  }
  mytee_wrapper(u32 msg, u32 mmio_addr) {
  int ret;
  ret = mytee_verify_mmio(MAILBOX_WRITE, mmio_addr, sizeof(u32));
  if (!ret) {
  mytee_log_trx(MAILBOX_WRITE, msg);
  write1(msg, mmio_addr);
  }
  }
  static int bcm2835_send_data(struct mbox_chan *link, void
*data) {
  ...
  mytee_priv_up( );
  mytee_wrapper(msg, mbox−>regs + MAIL1_WRT);
  mytee_priv_down( );
  ...
  }
```

### MyTEE APIs

| | |
|---|---|
| mytee_priv_up | |
| mytee_priv_down | |
| mytee_copy_value | omitted when the value is passed to |
| | the register |
| mytee_verify_memcpy | |
| mytee_log_trx | context |
| mytee_lock_controller | |

In order to demonstrate the feasibility of the peripheral device isolation technology described above, an example of safely utilizing a peripheral device in the TEE may be implemented. Specifically, it may enable TEE-only use of a TPM using the SPI protocol, a USB keyboard based on DMA and USB, and a framebuffer using a GPU.

### —Secure TPM

TPM may be a hardware chip that performs operations such as hash operations, key generation, random generation, and the like.

Infenion may provide TPM hardware chips and related software. The hardware may be plugged into the GPIO pin and may communicate on the basis of the SPI protocol. A kernel driver may be provided in the Linux mainstream in order to help the application use TPM. The software may include the pDRV and cDRV described above, and the pDRV may receive a TPM request transmitted from the user application, may convert the same into an SPI message format, and then transmit the same to the cDRV. The cDRV may transmit the same to the TPM chip through the SPI controller.

Thereafter, the TPM may perform the requested operation and then transmit the result value back to the cDRV through the MMIO.

MyTEE-based secure TPM may be activated as follows. The CA may load the TA. The TA may create the TPM command and then transmit the same back to the CA. Herein, the CA may stand for Client Application, and may refer to an application for calling a service in order to use TPM. That is, in a MyTEE-based secure TPM, the TA may create a TPM command and transmit the same to the CA to activate the TPM.

The CA sends the received command and a flag for requesting the secure TPM use to the write system call. After checking the flag, the pDRV may lock the SPI controller and may log the same. Also, after initializing the TPM, the received command may be set in the SPI structure and transmitted to the SPI CDRV. In the cDRV, myTEEsupported memwrite may be performed by checking the secure TPM flag added to the SPI S structure. First, the privilege may be escalated to the hypervisor through mytee_priv_up. Also, the spi structure may be copied to the secure stack. In addition to the command, the spi structure may store command length information, because it should be verified before writing and should not be subject to a toctou attack. After verifying the memory write on the basis of the copied structure, write may be performed. The write may write 1 byte at a time in a way of performing in a loop based on the length information. After finishing writing, the written command may be logged. The kernel privilege may be returned.

After waiting for a certain period of time, the result value of the TPM may be read, and the response message may be also performed in a similar manner through the command delivery and privilege escalation. At this time, depending on the TPM working state, it may be necessary to make several read attempts. The first byte of the success response message may start with 0x0, so it may check and read one byte at a time in a loop and store the same in secure memory. In addition, a dummy value may be inserted into the buffer originally used by the kernel to prevent exposure. After the completion of the operation, the CA may notify this and the TA may use the TPM generation value after verifying the logged information.

### —Secure I/O

As mentioned above, using TrustZone's TZASC and TZPC, I/O devices can be dynamically mapped to a single domain and connected to be used exclusively. In order to demonstrate that MyTEE can effectively protect I/O peripheral devices without using such hardware devices, the data protection technology for keyboard input and monitor output connected via USB may be implemented as an example.

### —Trusted Keyboard

General USB peripheral. A USB keyboard may be used as a trusted input device in our experimental environment. The operating method of a general USB keyboard may be described in this chapter. In general, a USB device can have multiple configurations. Each configuration may define several interfaces, and may have one or more interfaces depending on the type of the peripheral device. For example, a headset may have interfaces for microphones and audio. Also, each interface can have multiple endpoints depending on the supported transmission type. The endpoints may be used for communication between hosts and peripheral devices. Each endpoint can be divided into IN and OUT, where IN is used to transfer data from the peripheral device to the host and OUT is used to transfer data from the host to the peripheral device.

In particular, endpoint0 may be used for the control mag transfer to fetch the configuration of the peripheral device or to set hardware settings of the peripheral device. In the case of a USB keyboard, a command to turn on the LED may be delivered through OUT endpoint0.

In Linux, messages sent and received from the host to the peripheral device may be called a USB request block (URB). The URB may be generated by the pDRV and may have all the information necessary for transactions (e.g., entry point, device address, buffer address, etc.). The cDrv receiving the URB from the pDrv may initiate a transaction to the USB controller on the basis of the URB information. In general, there are multiple channels for communicating with a device in the USB controller. Each channel may have the same set of the set registers, which are mapped to the host memory. The cDrv may select an idle channel to be used for the communication with the device and may set the device information for the corresponding channel by using the dev address and entrypoint information extracted from the URB. Meanwhile, the buffer of the host memory in the URB may store data necessary for the communication between the host and the device. For example, when the host changes the device setting, the control msg may be stored in a buffer and delivered to the device through the controller.

In addition, in order to deliver the key input to the host, the key information input from the device may be written in the buffer. When the USB controller has its own DMA engine, the operations of reading and writing values to the buffer can be performed through the DMA. To this end, it is necessary to set the address of the buffer to be used in the dma address register of the previously selected channel.

After finishing the DMA transmission, an interrupt may occur and a pre-registered irq_handler may be executed in the pDrv.

irq_handler may retransmit the URB on the basis of the URB information updated by the current transaction, or may perform the necessary operations when successful. For example, when the URB for reading the key input is processed normally, the key input information may be obtained from the buffer in the URB, converted for the device, and then written to a kernel structure that can be consumed by the user application.

### Trusted Keyboard.

A trusted keyboard may be implemented on the basis of the analyzed contents. For the trusted keyboard, the following factors should be considered. (1) The user should be able to recognize that the keyboard is currently properly protected. (2) The confidentiality of the key input should be guaranteed. To meet these requirements, the design may be as follows.

Control message inspection. First, the LED for the NUM key may be used as an indicator indicating that the trusted keyboard is activated. Therefore, the LED key should be turned on only when requested by the TA. The TA for using the trusted keyboard may store a flag for the request to use the trusted keyboard to the CA in the secure memory region and may transmit the request to the CA. Thereafter, the CA may request LED ON of the NUM key, the indicator of the trusted keyboard, through a virtual keyboard command. This may trigger the pDrv of the USB keyboard to generate and transmit a URB containing a control msg to the Keyboard. The control msg may be transmitted to the OUT entrypoint0 of the keyboard device through the channel of the USB controller as described above. As mentioned in Section ( ), all DMA packets should be monitored. To this end, the dma address register of the USB controller mapped to memory may be protected by S2. The protection may be done in the smallest unit of 4 KB, and since the setting registers of all channels are located within 4 KB, the setting registers of all channels may be protected. Therefore, all the channel settings of the USB controller described above can cause S2 faults and be monitored. Using this, additional channel settings in addition to the dma address monitoring may be monitored so that the NUM LED operates only when normal. The main monitoring targets may be the device information setting of the channel and the buffer address setting. By decoding the value written to MMIO in the s2 fault that occurs when setting the device information, devaddr may be extracted and compared with the pre-stored devaddr to verify whether the current channel setting is for the keyboard device. In addition, the channel number may be found out on the basis of the address where the fault occurred. Each channel may map the same set of the setting registers to memory consecutively, so the current channel number can be found out on the basis of the offset between the fault address and the first setting register of the first channel. Also, when a fault occurs when setting the buffer address for the subsequent DMA, it may be determined that the buffer setting is for the keyboard channel on the basis of the previously identified channel number. When true, the value to be written to the address that caused the fault (the value of the buffer) may be copied to the hypervisor region and then decoded to determine whether to be a control message for LED ON.

In the case of true, after checking whether the trusted keyboard flag of the TA is set, write may be emulated to turn on the LED. In the case of false, the msg may be dropped. Through this, (1) may be satisfiable.

Herein, the devaddr may become the main attack vector. Since whether the current control msg is for the keyboard is determined on the basis of the devaddr, so when the actual devaddr of the keyboard changes, it is possible to induce the user to input secret values by turning on an indicator LED without activating the trusted keyboard mechanism. In order to solve this problem, MyTEE may keep track of whether the devaddr changes. For this, in addition to the control msg for turning on the LED, two standard control msg may be additionally monitored. All USB devices may have a default address of 0x0 when first attached to a port. The kernel may fetch the device information by delivering GET_DESCRIPTOR control msg to this address, and MyTEE may decode the corresponding message and check the class and protocol values to determine that it is a hid keyboard device. Subsequently, the kernel may allocate a new address through SET_ADDRESS control msg, decode the msg, and store the newly allocated devaddr as the address of the protected keyboard. Afterwards, an attacker may attempt to change the device's address using the SET_ADDRESS control msg and in order to prevent this, the SET_ADDRESS type control msg may be monitored at runtime.

### Key Input Protection.

The confidentiality guarantee for key input may be also performed on the basis of MMIO monitoring. Like the previous control msg protection, the currently allocated channel number may be obtained using the s2 fault that occurs when setting a USB controller channel to get an input from the keyboard. Then, when attempting MMIO for setting the address of the dma buffer, the S2 fault corresponding to the previously obtained channel may be trapped and the address of the buffer may be switched to the secure buffer address. The corresponding buffer may not be accessible in the kernel, but the hardware performing DMA may be accessible, so that the input information on the keyboard can be obtained.

The buffer storing the key input information may be accessed by the handler for processing the interrupt according to the completion of the DMA. This buffer may be present in the protected region, so it cannot be accessed by the general kernel code. This can be solved by the method mentioned in the section. However, the parts accessing the buffer may be scattered here and there in the handler, so it may not be easy to protect them by wrapping them one by one. Thus, it may be processed with the escalated privilege using mytee_priv_up API by implementing a function of converting the location information of the input key stored in the buffer into a keycode and storing the same in a secure memory accessible from the TA in a more coarse grained way.

For reference, the current implementation may be implemented to the extent that simple alphabetic keys and numeric keys are converted. In the actual kernel code, a logic for transferring the corresponding input event to another device and processing the same separately may be implemented for the case of a special key (e.g., sound) after key conversion, but in the implementation of the present exemplary embodiment, it may be delegated to the normal kernel to handle. In addition, the keys processed with the escalated privilege may be also changed to dummy values to be processed in the existing kernel. Another limitation may be that the key inputs are not processed in real time.

That is, after finishing the input through the execution of a function such as scanf in the poc code, the CA may call the TA again to use the value written in the protected memory. For real-time processing, the interrupts generated by the key inputs may be delivered to the TEE and should be processed by the handler inserted in the TEE, but this may complicate the design and require more changes in the privileged software. In addition, above all, there may be a possibility of increasing risk by loading an additional driver in the TEE.

In addition, rather than using priv_up/down for most MMIOs, the logic of the handler may be added to the trap of the DMA Filter implemented with hypervisor code. This is because the USB uses the DMA and the method of leaving logging and verifying it later cannot be adopted. Since incorrect DMA use is done by the code changes, the logging performance itself cannot be guaranteed.

### —Trusted Display

Along with the trusted input, the trusted output for showing correct information may be also important. For this, a technique for protecting the framebuffer using MyTEE may be designed. On Raspberry Pi, the memory to be used in the framebuffer may be allocated by the video core GPU. This may be performed by the kernel sending a request message toward the videocore. The inter-processor communication between the CPU and the GPU may be performed by the mailbox controller, and may be performed by delivering the request to the MMIO like other methods. For example, when the user application requests to change the display setting through the framebuffer pDrv, the corresponding request may be formatted as mailbox msg and may be written to the memory mapped register of the mailbox controller through the cDrv. In order to ensure the trusted output, the fb or the display settings should not be changed arbitrarily by the attacker while the display is used by the TEE. Therefore, the mailbox controller may be first locked. The lock may set the display's settings as a default value and may protect the mmio part of the mailbox controller using the s2 paging.

Therefore, all messages heading to the video core after the lock may be trapped and verified, and all display-related requests may be dropped by decoding the message type. The requests except the display (clock rates) may be allowed. After that, the TA may deliver the request to the framebuffer pDRV through the proxy CA for the framebuffer access. In general, the method where the application writes values in the framebuffer can be divided into the mmap method and the write method, and we describe the method of implementing a trusted display in both methods.

### —MMAP-Based Access

The user application may directly read and write framebuffers through mmap for framebuffer physical regions. To support this method, MyTEE API may be inserted at the end of the mmap handler of the framebuffer pDRV. When the mmap requested by the proxy CA is performed normally, the inserted code block may serve to verify the start address and size of the physical region mapped by the mmap, to lock the framebuffer region on the basis of this, and to insert the corresponding information into the protected region. Later, the TA may map to its own region on the basis of the lock log for the preceding mailbox controller, the fb buffer region lock log, and the stored fb physical address and may directly manipulate the fb.

The physical address of the fb buffer cannot be known in advance when verifying, so the method of verifying whether to be a physical address determined using the context cannot be used as described in the section. Therefore, whether the corresponding physical address is a hyp or TEE address may be simply checked and this may be sufficient to implement a trusted display. This is because even when an attacker provides an address other than the actual fb address, the secret value is not exposed due to the TA writing to the protected region, and the corresponding region is not displayed so the user can know that it is abnormally protected. In addition, the framebuffer itself may check the mapping location, length, and the like, so that a boomerang attack cannot be performed even when the compromised CA manipulates the information (e.g., the offset or size to mmap) transmitted from the TA. In addition to this method, there is also a method of finding out the address of the current fb by performing the controller mmio of the mailbox in the validation function. However, in addition to writing the msg to mmio, additional function implementations such as the timer setting and the synchronization should be integrated.

### —Write System Call

Another way to write values to the framebuffer may be a method of delivering data through a write request to the pDrv and allowing the driver to write the value to the fb. When the TA just delivers the display data to the CA, there are risks of content exposure and tampering. Therefore, the TA may store the display data in the hypervisor memory and may request the CA to use the trusted fb along with the data size to be written in the fb. The CA may perform a write system call for the fb on the basis of the received information. Herein, the CA may be a component responsible for loading a trusted application (TA), calling a function of the hypervisor or operating system by processing the request delivered from the TA, and performing security control. That is, it may serve to act as an intermediate medium between the TA and the hardware.

In the pDrv, the controller and fb may be locked first as before. Then, the display data of the hyp region written by TA may be read and written to the fb. At this time, the log verification previously performed by the TA in the mmap method may be also performed. These operations may be wrapped with priv_up since the operations need to access the hyp memory in the kernel.

### Implementation

The PoC of MyTEE may be implemented on an rpi3b+ board equipped with a quad-core ARM Cortex-A53 processor. The OP-TEE may be used as the TEE software, and Linux version 4.14 may be used as the OS. Details related to the implementation of the MyTEE are as follows.

### —ARM Trusted Firmware

A function for generating the S2 page table mapping for the kernel region at boot time may be added. In particular, the region for storing the protected buffer of the USB keyboard may be mapped to the dma coherence region to enable the communication with the hardware without the cache flushing. In addition, a critical function such as a page table, a base register, and the like may be serviced in the kernel at runtime and the monitor vector may be changed to add the s2 page table change function for protecting the MMIO region of the controller with RO by MyTEE API.

### —OS Kernel and Drivers

The large page extension function may be activated using the LPE option so that the kernel and the hypervisor use the same page table format. At boot time, the memmap option may be used to reserve a 16 MB hardware region as the hypervisor region and to create a virtual address mapping. After the kernel and the hypervisor region embedded in the kernel are loaded into memory, the code for calling a service for protecting with the S2 page may be added to the init function. In addition, the commands for performing to change the page table and the base register may be patched with SMC to verify and service the corresponding service in the TEE.

In addition, MyTEE API for implementing the TPM example may mainly patch the TPM pDrv code (drivers/char/tpm/tpm_tis_spi.c, tpm-dev.c) with the SPI controller driver (drivers/spi/spi-bcm2835.c), the framebuffer driver code (drivers/video/fbdev/core/fbmem.c) with the mailbox controller driver (drivers/mailbox/bcm2835-mailbox.c), and the USB keyboard pDrv (drivers/hid/hid-core.c, drivers/hid/usbhid/hid-core.c) with the USB controller driver (drivers/usb/host/dwc_otg/dwc_otg_cil.c). Besides, a flag indicating the use of trusted peripheral devices may be added to the spi (struct spi_transfer), mailbox (struct mbox_chan), and usb (struct urb) of each protocol.

### —Hypervisor

The hypervisor may be implemented from the beginning. HTTBR may be set to use the TTBR value used in the kernel at boot time. The logic servicing the MyTEE API using hypercalls may be processed by the hypervisor, so that the code for the DMA packet filter and the command emulation may be implemented as vectors as well.

### —OP-TEE

There is no change in the OS level. Mapping may be necessary in order to write and read data in the hypervisor region in the TA. This may use API basically provided by the OP-TEE. In addition, the function of the log verification may be implemented as API in each fb and TPM example.

### Evaluation

### —Security Analysis

### —Race Condition Attack.

The logging may be performed in the privileged code blocks to prevent attacks where an attacker bypasses the MyTEE API inserted into the kernel or manipulates the commands passed to the peripheral devices. A possible attack scenario may be a race condition attack between the verification and the use in a scenario where the TA checks logging, like the TPM.

For example, when attempting to use the value written in the protected buffer after verifying the logging, an attacker can attempt to manipulate with a predictable value by sending a command to a peripheral device using a priv block in another core. In order to defend against these attacks, the TA may first copy the value in the buffer into its own region to perform the verification. In addition, by performing the logging just before write within the priv up/down block, the logging may be prevented from being performed after finishing the copying and the verification by the TA. In the case of the write method in the framebuffer, the kernel code with the escalated privilege may read the value from the protected buffer and may write the same to the fb. At this time, there may be an attempt to manipulate the content of the fb by using the code block with the privilege escalated in another core. Herein, the fb may represent the framebuffer and may refer to a memory region related to screen output. Such an attack may be impossible in that the escalated code block always reads values only in the protected buffer that only TA (Trusted Application) can write to and writes the same in the fb.

### —Abusing MyTEE API

When an API that escalates the privilege of a part of the code to the hypervisor privilege is used by an attacker at will, the attacker can take control of the entire system, including the TEE. Although the TEE region is not mapped, the attacker can create a new mapping on the TEE side by manipulating the values in the hypervisor's page table based register. In order to prevent this attack, the priv up code may be executed only in the statically compiled region of the kernel. In addition, there may be an attempt to exploit the API and memwrite already inserted in the kernel driver. To this end, the region may be verified on memwrite, and in particular, the current controller information may be delivered together at the time of the verification, so that a specific priv up API can access only the MMIO region of the controller of the driver where the corresponding API is inserted. By doing so, the privileged write attempt of the driver A can be ensured not to manipulate the MMIO region of the driver B.

### —Code Vulnerability.

The code in the priv up/down block may be a very simple function like memcpy or write1. Therefore, it is possible to easily verify. In the case of the fb, the key code conversion code may be by the block. However, this may be also small enough to be verified. Even when the code in the block is exploited to change the control flow, the attacker cannot attack the TEE because the commands to update the page table base register do not exist in the kernel and the hypervisor. One possible attack option may be an attack by 1 km. When placing the corresponding instrumented code into the dynamically loaded kernel driver and jumping to the corresponding location, a mapping for the TEE may be created to enable the attack. This attack may be possible by adding additional security elements when entering priv up. For example, the mapping for the 1 km region may be removed on priv_up and may be remapped when down.

The use of the TEE in embedded devices may be limited due to the absence of hardware functions or access permission restrictions. In order to solve this problem, MyTEE may be designed for utilizing the advantages of the TEE even in devices with limited TEE hardware access. By using MyTEE, the TEE isolation and secure use of peripheral devices may be possible without the memory protection or the secure IO channels which are extended hardware functions of the TrustZone. In particular, the use of secure peripheral devices may be possible by embedding the MyTEE API into the device driver, so existing device driver developers can easily use it. Three TEE applications (Secure TPM and Trusted Keyboard and display) may be implemented by utilizing MyTEE to demonstrate feasibility.

Hereinafter, the system for implementing a software-based trusted execution environment for an embedded device according to an exemplary embodiment of the present disclosure will be described in detail.

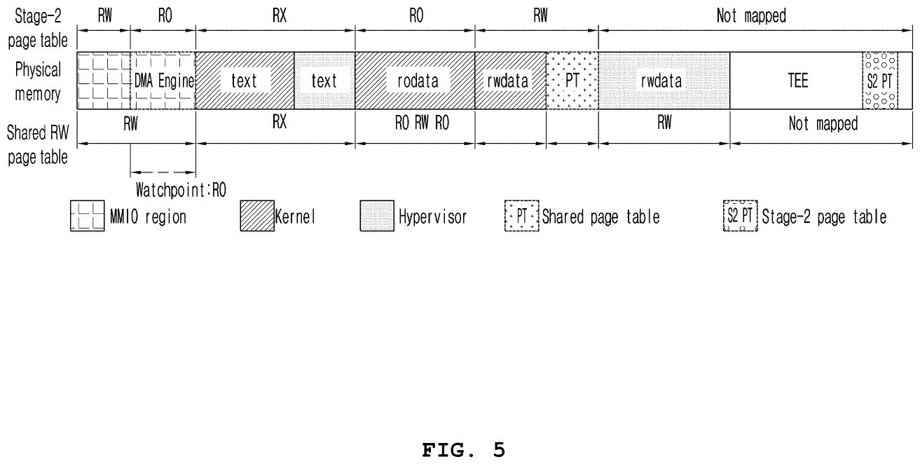

FIG. 5 is a view showing a physical memory layout and memory permission settings for protecting TEE and MyTEE components. The system for implementing a software-based trusted execution environment for an embedded device according to the present exemplary embodiment may first set the physical memory layout in order to protect components of the TEE and MyTEE. This may be necessary to isolate the memory space used by the TEE and MyTEE from other system regions. In addition, the memory space may be set up with specific permissions to prevent external malicious software from invading the memory.

The TEE and MyTEE may operate in a space separated from the REE (Regular Execution Environment) such as the Linux OS. To this end, in the memory layout, the memory space that the TEE and MyTEE will use should be separated from the REE. In addition, the permission setting for this memory space may be essential in order to protect the TEE and MyTEE.

Usually, the register settings may be used to protect memory. For example, the ARM architecture may use a memory management unit (MMU) to manage the page tables and set the access permissions for each page. In the TEE and MyTEE, the memory protection may be implemented by changing register values using the MMU settings. In addition, the TEE and MyTEE may manage the page tables and perform necessary permission settings. The physical memory layout and memory permission settings may be one of the important factors to ensure the security of the TEE and MyTEE components.

In relation to the execution environment isolation, the MyTEE may be composed of the TEE and REE components. The tiny hypervisor and the MyTEE APIs implanted in the device driver may constitute the REE component. The active integrity monitor as the TEE component may run in monitor mode to emulate the critical operations of the kernel and hypervisor. Both components may be protected by carefully managing the kernel page table and the stage-2 page table.

First, MyTEE may ensure that an untrusted OS cannot access both regions by removing the mapping for the TEE and hypervisor from the stage-2 page table. In addition, the kernel text embedding MyTEE API calls and the hypervisor text may be also forced to be read-only. The stage-2 page table may be created as part of the secure boot.

For the privilege escalation of the device driver (V-D in FIG. 1), the hypervisor may use the kernel page table to map the virtual address space instead of managing its own page table. This method may enable the privilege escalation code block to run seamlessly with the hypervisor privilege. That is, kernel APIs and dynamically allocated kernel objects can be accessed from the hypervisor using the kernel virtual address without being mapped into the separate hypervisor page table. For this, the kernel page table may map the entire REE (including the hypervisor), except the TEE. However, the untrusted OS cannot access the hypervisor region due to the stage 2 paging-based isolation. In addition, the active integrity monitor may restrict the privilege of the kernel and the hypervisor to prevent untrusted OSs or compromised hypervisors from manipulating the page tables. The (shared) kernel page table may be set to be read-only, and the integrity monitor may verify and emulate the page table update. This may ensure that the new page table entry does not map to the physical memory that is already allocated to the protected components and invariants (e.g., TEE, hypervisor, kernel text).

The security-critical operations, such as additionally managing system registers, may be simulated. commands for such critical operations may be replaced with the secure monitor call (SMC). The stage-2 page table may be located in the TEE region that is not mapped to the untrusted user operating system, so it can be protected even when the hacker obtains the hypervisor privilege. The security-critical commands for managing the hypervisor system register may be guaranteed not to be included in the hypervisor. For example, commands configuring the hypervisor's VTTBR and the system control register (SCTLR) may be initialized at boot time and then may be removed from memory. VTTBR may be a register indicating the start address of the virtualized page table for converting virtual addresses into physical addresses. SCTLR may be a register for performing the control of the entire system in ARM architecture. This register may control functions such as cache, virtual memory, and interrupt management, for example. In MyTEE, the commands configuring VTTBR and SCTLR may be initialized at boot time and then removed from memory. This may prevent malicious attackers from exploiting these registers.

Finally, a watchpoint-based memory protection technique may be adopted in order to monitor malicious access with the privilege to the DMA controller register. FIG. 5 may show a memory layout with MyTEE.

In relation to the DMA Filter, since there is no TZASC, MyTEE may depend on careful page table management and the privilege restrictions for the memory protection of itself and the TEE. This may mean that the compromised peripheral device can be vulnerable to DMA attacks that can read and write any memory region arbitrarily. The DMA attack can be triggered by two different entities: malicious hardware or untrusted operating systems. In the present exemplary embodiment, it is assumed that the host device is physically isolated and the peripheral device on the device is not malicious. Thus, the DMA attack by malicious hardware may not be considered in our work. On the other hand, the untrusted operating system can break the MyTEE security by maliciously programing the DMA controller. In order to prevent this, the MyTEE may filters out malicious DMA requests that can cause abnormal behavior. Since there are two types of DMA controllers, the built-in DMA controller and the external DMA controller, slightly different monitoring strategies should be applied.

External DMA Controller. The MyTEE may monitor all DMA control blocks (CB) in order to protect the external DMA controller. The CB may be a data structure that specifies mandatory information necessary for transmitting data, such as source and destination addresses, data size, and transmission types.

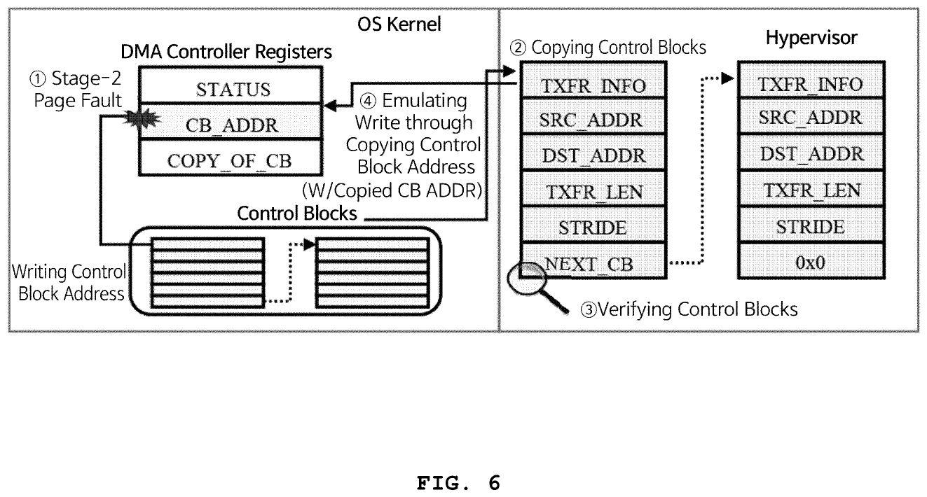

FIG. 6 is a view for describing that MyTEE verifies a DMA control block in order to prevent a malicious DMA from being triggered by an untrusted operating system. As shown in FIG. 6, because the address of the CB may be delivered to the DMA controller through MMIO, MyTEE may trap and validate any access to the memory-mapped registers of the DMA controller. In other words, the stage-2 paging may be leveraged to lock the registers. Accesses to the locked registers may generate page faults that are trapped by the MyTEE hypervisor. MyTEE may first dereference the CB address and may copy the CB to the secure memory. Because several CBs can be chained together by setting the NEXT_CB, the dereferencing and the copying of the CB values may continue until the NEXT_CB is set to 0x0. Then, the copied CBs may be verified to hinder the DMA from accessing any protected region. The data transmission of DMA may be performed in different ways depending on the TD_MODE flag setting in TXFR_INFO.

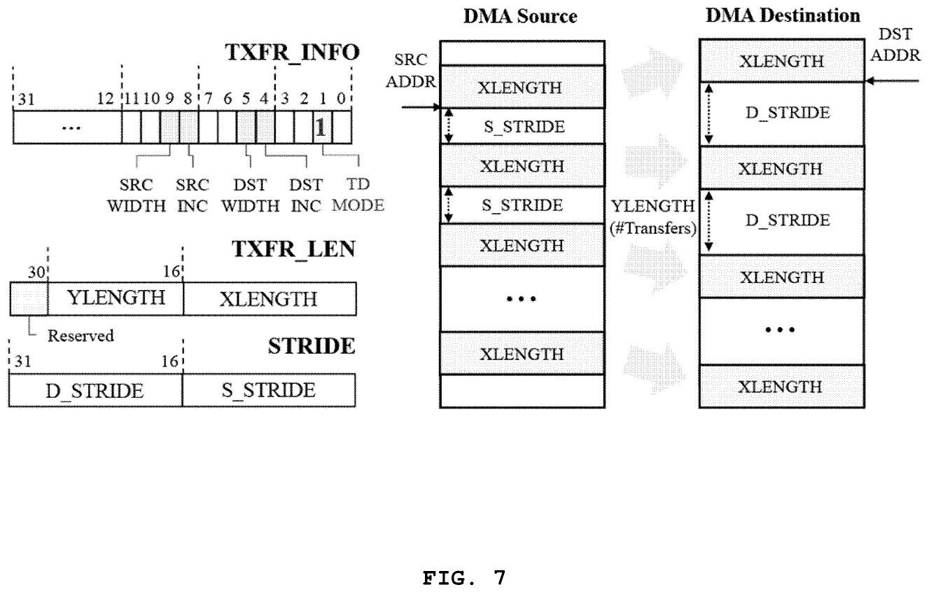

FIG. 7 is a view for describing that MyTEE checks a CB setting in a DMA two-dimensional (TD) mode to ensure that DMA does not access a protected region on each data transmission iteration.

As described in FIG. 7, when the flag is set, the transmission between the source and destination memory buffers may be performed in two-dimensional (TD) mode. The source data, the size of which is specified by XLENGTH, may be transferred to the destination memory.

In addition, the transmission may be performed YLENGTH times. D_STRIDE and S_STRIDE may contain signed integers and may be added to SRC_ADDR and DST_ADDR, respectively, to determine the source and destination addresses for the next transmission. The SRC_WIDTH, SRC_INC, DST_WIDTH, and DST_INC flags in TXFR_INFO may also configure the addresses for the next transmission. Specifically, when the SRC_INC or DST_INC flag is set, each memory read from source or write to destination may increase the source and destination addresses by 4 or 32 depending on the settings of SRC_WIDTH and DST_WIDTH. On the contrary, the normal (non-TD) mode may work in an even simpler manner. TXFR_LEN as a whole may specify the amount of data to be transferred. STRIDE may be also ignored in this mode.

On the basis of the observation of how the CB programs the DMA controller, MyTEE may verify expected accesses by the DMA in advance to filter out malicious CBs. Any CB that programs the controller to perform the DMA to the immutable region (i.e., kernel text, hypervisor, TEE) may be considered malicious and blocked. Herein, the CB may be an abbreviation for “Control Block” and may be a data structure used for direct memory access (DMA) control. The CB may be used to configure data required for DMA transmission as a control register. The CB may be stored in a fixed location in the memory, and the DMA controller may read the CB to perform data transmission. The CB may contain information on DMA transmission such as DMA transmission size, source and destination addresses, transmission modes, and the like.

Finally, the address of the copied CB, instead of the original one, may be written to the DMA controller register to remove the race condition between the verification and use. Once the address is written to the controller register, each field of the CB may be copied into the read-only registers in the controller (COPY_OF_CB in FIG. 6). In addition, the DMA may be allowed to access the secure buffers only when both the source and destination buffers are hosted in secure memory. By doing this, secrets in the buffer may be prevented from being leaked or manipulated by malicious DMA.

Built-in DMA controller. The DMA controller can be integrated into other devices. On the Raspberry Pi 3, the USB controller may incorporate its own DMA controller. Compared with the external DMA controller, this type of built-in DMA controller may have a simpler configuration mechanism. Instead of first locating in the memory and being subsequently subsumed by the DMA controller, the DMA CB may enable an OS to directly update the memory-mapped controller registers that configure the size and address of the data transmission memory. In addition, no memory-to-memory operation may occur with this DMA controller. Either the source or destination may be set to the FIFO of the peripheral device that is attached to the USB hub. For example, the DMA operation for fetching the USB keyboard input may be performed to be read from the FIFO and to be written to the buffer in host memory. This nature of the built-in DMA controller may simplify the DMA filtering. The controller registers may be locked by stage-2 paging to monitor any attempt to update. However, copying the CBs in secure memory may not be required. In particular, the updates to the registers for configuring the buffer address and its size may be investigated to prevent the DMA from accessing the kernel text and data, the hypervisor, the TEE, and the locked registers themselves. In addition, when not performed as part of secure IO transactions, any DMA access to the secure buffer may be removed.

In relation to the peripheral isolation, the absence of TZPC and TZASC may hinder the establishment of the TrustZone-based secure IO. Herein, how MyTEE establishes a secure IO channel between the TA and the peripheral devices without depending on such TrustZone extensions may be described in detail.
1) Design primitives for secure IO: Previous work enabled the secure IO between the TEE and the peripheral devices by configuring TZPC to set up the security state of peripheral devices to be secure so that the TZASC protected memory can be accessible. In addition, the peripheral device driver may be hosted in the TEE. However, this approach cannot be applied to a limited environment that does not provide such hardware protection units. In addition, porting the device driver to the TEE may also enlarge the attack surface of the TEE. MyTEE may address these limitations and satisfy the following requirements: R1) should not bloat the TEE, R2) is easy to use and deploy, R3) ensures IO is verifiable, and R4) should not be abusable.
2) Temporary privilege escalation: To satisfy R1, the device drivers may be reviewed instead of hosting in the TEE. The CA may function as a proxy to deliver the request from the TA. As already illustrated before, the pDrv, cDrv, and controller may be involved in the communication with peripheral devices. A part of them may be protected to enable secure IO with the peripheral device. That is, they may be namely the memory mapped registers of controllers and buffers that are used to deliver IO requests and responses. The requirements of preserving confidentiality or integrity of the secure buffer may differ depending on the type of peripheral device and scenario. For example, both confidentiality and integrity should be ensured for medical data in the framebuffer. Meanwhile, the TPM command in the buffer may not be a secret but should be delivered intact to TPM. Herein, the TPM may an abbreviation for Trusted Platform Module, and may refer to a chip or module designed to enhance the security of computer hardware or software. TPM may provide a variety of security functions, such as generating and storing encryption key, managing digital certificates, and validating the system boot process. TPM commands may be commands sent to the TPM to perform these functions, such as “instructing the TPM to perform trust verification”.

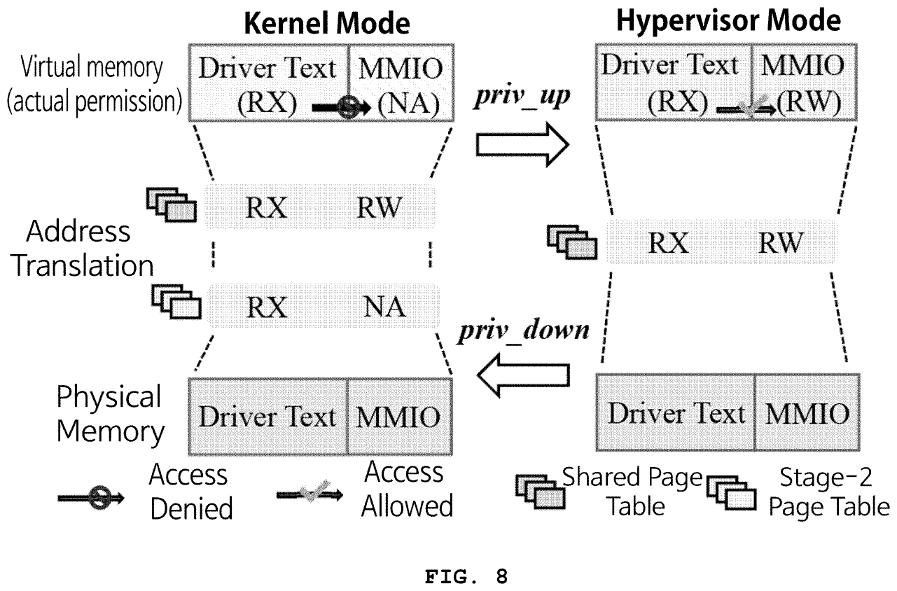

FIG. 8 is a view for describing that a temporal privilege escalation of a device driver partition and a combination of shared and stage-2 page tables enable secure IO without bloating TEE.

FIG. 8 shows how to implement secure IO in MyTEE as follows. The memory-mapped registers may be set to be non-accessible from the OS by managing the stage-2 paging. The predefined IO buffers in secure (hypervisor) memory may be used on demand, instead of kernel-allocated buffers. Accordingly, even the device drivers that are engaged in secure IO cannot read from or write to these shielded objects. Thus, the privileges of code blocks that manage the secure buffer and register may be temporarily escalated so that driver operations are not blocked. The page table may be shared to map both the kernel and hypervisor. However, since the actual kernel space permission is determined by the combination of settings of the kernel and stage-2 page tables, sharing the page table may not undermine the hypervisor security. That is, still different memory permissions can be applied between the kernel and hypervisor and the shielded objects may be accessible only when the privilege is escalated to the hypervisor.

TABLE 2

| Name | Description |
|---|---|
| mytee_shield_mmio( ) | Protect the MMIO region using the stage-2 paging |
| mytee_priv_np( ) | Escalate the privilege to hypervisor |
| mytee_priv_down( ) | Restore the privilege to kernel |
| mytee_verify_memopr( ) | Validate the address and size of memory operations |
| mytee_log_txn( ) | Create a secure log for the privileged operations |

The privilege escalation may be conducted using MyTEE APIs, such as mytee_priv_up and mytee_priv_down, which wrap the selected code blocks (Table 2). The APIs may be implemented as hypercalls. Once the mytee_priv_up is invoked, the current CPU mode may switch to hypervisor, a new stack may be allocated in secure memory, and the interrupt may be disabled. Although the hypervisor may be trustable, the privilege-escalated code chunk could be vulnerable, giving an attacker a chance to obtain the arbitrary read/write primitives with hypervisor privilege. This might lead to corrupting the DMA controller to collapse the paging-based TEE isolation. In order to prevent this attack, the debug watchpoint-based memory protection may be adopted. The watchpoint may be configured to monitor the MMIO region for the DMA controller at every privilege escalation. Hence, any write access to the controller may generate the watchpoint exception that is trapped and handled by the trusted hypervisor. Finally, the control flow may transfer to the instruction following the hyper invocation without deprivileging to kernel. Thus, the code block after the mytee_priv_up may execute with hypervisor privilege and hence can access the secure buffer and register. The mytee_priv_down may be placed at the end of the code block and may draw back what is set by the mytee_priv_up. In order to prevent the attacker from abusing these APIs, only the drivers that are statically built as part of the kernel text may be enforced to use the APIs. The link register (LR), which is automatically updated with the return address when a function is invoked, may be checked to distinguish kernel text from the loadable kernel modules (LKMs).

Thanks to the use of MyTEE APIs, a secure IO channel with a peripheral device can be readily established (satisfying R2), and this may help to minimize the modification of the privileged software (i.e., hypervisor) to reflect the peripheral specific logic and data structure. For example, all commands sent to the TPM (Trusted Platform Module) hardware should be logged for future verification by the TA. This logging may be required to understand the semantics of TPM and protocol, such as the TPM command and the SPI message formats.

Herein, the SPI (Serial Peripheral Interface) may be one of the communication protocols for serial communication between hardware devices. This protocol may be composed of four signal lines for data transmission and may be mainly used for communication between microcontrollers and peripheral devices. The SPI may use a synchronous communication method and may be configured so that when one device transmits data, another device can receive it. The SPI may be one of the common communication protocols supported by most microcontrollers and peripheral devices.

Using MyTEE APIs may enable developers to manage such peripheral specific data and logic in the relevant device drivers instead of having to adapt the MyTEE hypervisor.
3) Robustness and security: Since MyTEE API calls in the device drivers are exposed, they can be abused or bypassed by potential attackers. The attackers can simply bend the control flow to ensure that the MMIO regions are not shielded. In addition, the privilege-escalated code blocks can be abused to send malicious requests to the peripheral device. In order to mitigate this, it may be better to enforce operations in the privileged code blocks to be logged and to allow the TA to verify the operations (R3). The mytee_log_txn API may support logging, and may be invoked in the privilege-escalated block to log the events in secure memory. The operation type (e.g., shielding MMIO registers, writing a command), messages to the peripheral device, and configuration values of the controllers may be logged. The verification can be conducted as follows: check (1) whether the buffer and MMIO regions are shielded during a transaction and (2) whether the request delivered to the peripheral devices is intact. There could be malicious and multiple accesses to MMIO. However, logging performed in the privileged block may be non-bypassable, as long as the API is properly implanted. Once an unexpected log is detected (e.g., TPM command tampering), the TA can simply stop or continue iterating the transaction until it is normally achieved.

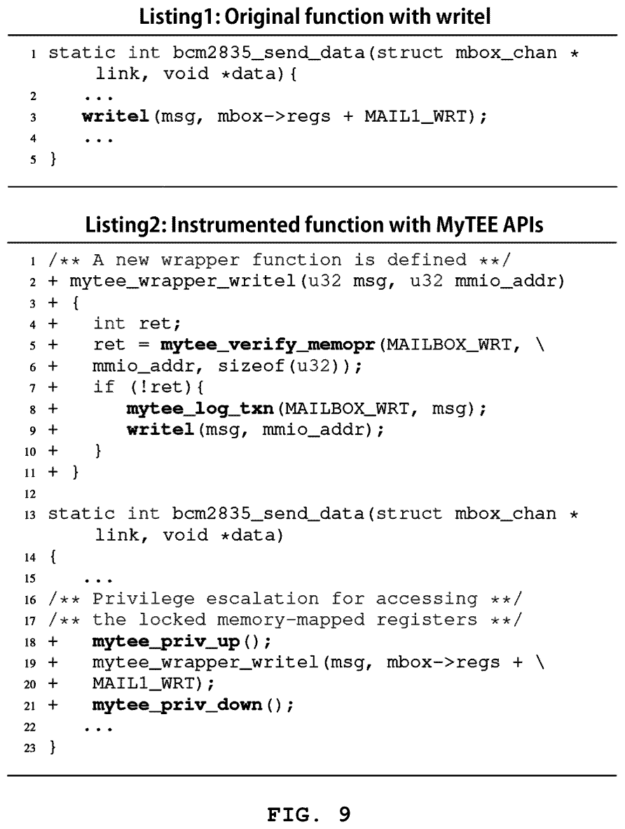

FIG. 9 is a view showing a listing 1 (an original function with write1 and a listing 2 (an instrumented function with MyTEE APIs).

The write1 may be related to write1, a function used to control hardware registers in Linux kernels, and the write1 function may write a specified value in the register by using memory-mapping input/output (I/O). That is, it may be used to change the value of the corresponding register. This function may be used in hardware drivers and may be used to read and write data in hardware. For example, write1 (0x1234, 0x400) may allow to write the value of 0x1234 in a register located at 0x400. This may allow to control hardware operations or change settings.

The memory operation (e.g., write1) in the privilege-escalated blocks should not be abused (R4) and for this, MyTEE may support the mytee_verify_memopr API. Since verifying the address and size, the addresses of the secure objects may be deterministic. For example, the MMIO regions for peripheral devices may be defined and fixed by the SoC manufacturer. The verification may be simply conducted by checking whether the memory operation is performed within the valid memory range. Relevant parameters (e.g., addresses of the source and target) and the corresponding referenced value may be marshaled into the secure stack before the verification to prevent time-of-check-to-time-of-use (TOCTOU) attacks.

In addition, the privilege-escalated driver block may be vulnerable. However, even when the attacker obtains the privileged “write-what-where” primitive by exploiting the vulnerability, the read-only regions may be still immutable. This may be because the TEE (i.e., active integrity monitor) is the sole anchor to update the page tables. Although the writable objects such as the log can be corrupted, the effectiveness of the attack may be confined to the REE. Accordingly, since the device driver is hosted outside the TEE, the attack cannot directly corrupt the TEE.

Finally, like general TEE services, MyTEE-protected services may be also vulnerable to the denial-of-service (DoS) attack. However, MyTEE may provide a way to build and indicator for secure IO activation in order to prevent masquerading unprotected IO as secure IO. In addition, in the case of simultaneous accesses to the IO devices from the REE and TEE, TEE access may be always given higher priority. This approach may align with general TEE-based secure IOs that freeze the REE while conducting the IO from the TEE.
4) Instrumentation example: Listing 2 may show an example instrumentation of a device driver using the MyTEE. On Raspberry Pi, the operating system can communicate with the GPU using the Mailbox protocol. The function bcm2835_send data may write a message through MMIO to the Mailbox controller so that it is delivered to the GPU. In the example, the MMIO region may be assumed to be already shielded, and every message written to the region may be attempted to be logged. As shown in Listing 2, we may first the original write1 function in the function, mytee_wrapper_write1, with additional MyTEE APIs for verifying and logging the write.

One of the input parameters of the APIs, MAILBOX WRIT, may be a constant value that indicates the current context. This value may be used in the verification function to retrieve a valid address range with the Mailbox controller. The developer can add finer-grained filtering logic to capture only a specific type of request message (e.g., display configuration) that is delivered by the Mailbox.

Since the mytee_wrapper_write1 is wrapped again with mytee_priv_up and mytee_priv_down, it may operate with the hypervisor privilege and thus can access the shielded MMIO region. In this example, the parameters for mytee_wrapper_write1 may not be marshaled because the size of the parameter is 4 bytes. Therefore, they may be delivered using general registers. However, passing address taken variables as arguments may require marshalling in the secure stack.

Marshal may refer to the process of converting data into other formats in computer science. For example, it may refer to the task of reading data from computer memory and converting the data into another format, or converting data to a specific format when transferring data between different systems or processes. It may be mainly used in programming languages or databases, and the size and type of data can be controlled by converting data to other formats.

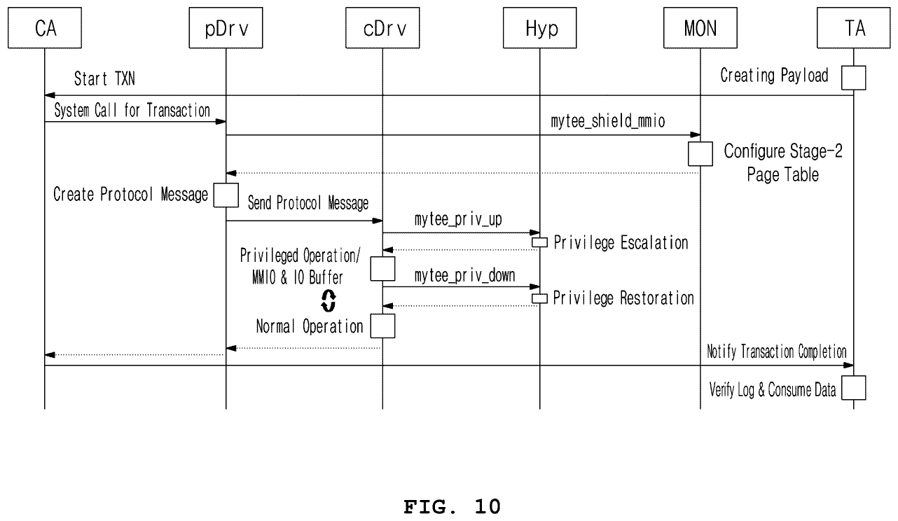

FIG. 10 is a view showing a communication process for secure IO.

In relation to secure IO applications, three examples may be explained to show how the communication channels between the TEE and peripheral devices, i.e., the hardware TPM, and USB keyboard, framebuffer, can be hardened with MyTEE in this section. Although implementation (particularly how the drivers are instrumented with MyTEE APIs) can be variable depending on peripheral devices, the MyTEE-supported secure IO can be exemplified as shown in FIG. 10.

### A. Secure TPM

For PoC of secure TPM, SLB 9670 TPM from Infineon may be used by us. The PoC may be an abbreviation for “Proof of Concept”, which means proof-of-concept. It may be mainly used in the field of computer technology and may refer to an experiment to confirm whether a new idea or technology works in practice. The PoC may be usually applied by creating a prototype or sample software, and may be to prove the validity of the idea or technology through the results. This may be a hardware implementation of TPM 2.0 and may be connected to the GPIO pins on Raspberry Pi 3. The communication between the OS and TPM may be performed using SPI protocol. The device drivers for TPM (pDrv) and SPI controller (cDrv) may be integrated in the Linux mainstream. Any request from a user application bounding for the TPM may be first delivered to the pDrv and may be formatted as a SPI message. Then, the message may be written to the TPM through MMIO to the controller. The response from the TPM may be also read from the controller through MMIO. Both MMIOs may be performed by the cDrv.

The secure IO to TPM may be built and may work as follows. The TA may create a TPM command and may deliver the same to the proxy CA. The CA may deliver the command with a flag requesting the secure IO to the pDrv. The MMIO region for the SPI controller may be protected by the mytee_shield_mmio in the pDrv and this shielding operation may be also logged in the secure (hypervisor) memory. After the TPM is initialized by an init command sent by the pDrv, the SPI message that embeds the command and flag from the CA may be sent to the cDrv. Once the cDrv checks the flag, the privilege-escalated MMIO may be performed. To realize this, the bcm2835_wr function may be instrumented in a similar manner as that illustrated in Listing 2. The function may be placed in the new wrapper function, then the mytee_priv_up and mytee_priv_down APIs may be invoked before and after the wrapper function. Additional APIs for parameter marshalling, memory write verification, and command logging may be placed in the wrapped function.

Specifically, the command and its length field may be marshalled in the SPI message. The bcm2835_wr function may write the command to the FIFO of the slave (TPM). One byte may be written per iteration in a loop following the SPI transmission protocol. Once all the commands are passed to the TPM, the privilege may be reverted back to the kernel.

Reading a response from TPM may require privileged read access to the shielded MMIO region. Therefore, the bcm2835_rd function may be instrumented in a similar manner. The read operation may be also fulfilled with 1 byte granularity. Each byte from the TPM may be written to the buffer in secure memory instead of the buffer in the SPI message. Later, the TA may verify whether the TPM request is managed in a trustworthy manner by checking the logs and then may consume the output in the secure buffer. The header of the TPM response message may contain a status flag for the transaction, and the response message with a success status may deliver the output (e.g., a random number) depending on the type of command. Thus, only responses with success status may be filtered and written to the secure buffer. In addition, a transaction flag that indicates the completion of a single transaction may be maintained to prevent further (malicious) requests from being made before the TA consumes the output. The flag may be checked as part of the validation of MMIO for writing a TPM command and may be cleared by the TA after the consumption of the TPM output.

### B. Trusted USB Keyboard

In this section, the communication mechanism between the host and general USB devices may be first described in detail and then, an example of hardening communication with a USB keyboard may be provided to demonstrate how MyTEE can establish a secure IO with the USB devices.
1) General USB peripheral devices: USB devices can have several configurations. Each configuration can also define several interfaces. For example, a USB headset may have interfaces for a microphone and for audio. Each individual interface may have at least one endpoint, which is a hardware buffer for communication between the host and the peripheral device. There are two types of endpoints: control endpoint and data endpoint. The control endpoint may be used to set up and control the USB device (e.g., LED control on keyboard), and endpoint0 may be dedicated for this purpose. The data endpoint may be optional and may be defined for data transmission. The direction of the endpoint may be defined on the basis of the host. For example, the IN endpoint may be used for transmission from the peripheral device to the host, and the OUT endpoint may transmit data from the host to the device.

On Linux, the USB Request Block (URB) may be a data structure defined for data transmission with USB peripheral devices. The URB may be created by the pDrv and may contain all the information required for the transaction (e.g., endpoint, device address, buffer address). Once the cDrv for the USB controller receives the URB from the pDrv, the USB controller may be configured on the basis of the information in the URB and may start the transaction. In general, USB controllers may support several channels for communication with peripheral devices. Each channel may have the same set of configuration registers that are mapped in host memory. As part of bootstrapping a transaction, the cDrv may select an idle channel and may configure the channel on the basis of the information in the URB, such as the device address and endpoint. The buffer address in the URB can also be configured to the controller to enable the DMA (Direct Memory Access) between the host and the peripheral device.

The completion of the DMA may incur an interrupt, and this may be handled by a kernel thread that invokes the interrupt handler registered by the pDrv. The handling of interrupts may be performed on the basis of the updated information in the URB. The handler may first check the status flag that indicates whether the previous transmission triggered by the URB is successful. The URB may be resent when the status flag sets to failure. The handler may execute peripheral specific service routines to handle the URB with a success flag. For example, the URB may obtain a scan code in the buffer and the handler may convert the scan code into the key code on the basis of the key map. In addition, the keyboard input may be written into a file so that applications can consume the events (e.g., /dev/input/eventX).
2) Trusted Keyboard: We may design the trusted keyboard with MyTEE by analyzing USB device drivers in Linux. The following security requirements may be considered for the trusted keyboard design: (1) A user should be able to recognize whether secure IO with the keyboard is currently established. (2) Confidentiality and integrity of the communication should be guaranteed.

Control message check. We may use the LED for the NUM Lock key as an indicator for secure IO activation. Thus, the LED should be turned on only when the TA initiates and requests the trusted keyboard. The TA may first set a trusted keyboard flag in the hypervisor memory and may ask the proxy CA to turn on the LED. Then, the CA may simply turn on the NUM Lock LED using xset utility. Herein, the xset utility may be a command-line tool used to change the properties of the X server used in the X Window System. Using xset, it is possible to change server settings such as screen brightness, enabling and disabling the screensaver, and the like. In MyTEE, the xset utility may be used to turn on the LED.

This may trigger the pDrv of the USB keyboard. In the pDrv, the URB for the control message may be created and sent to the cDrv of the USB controller. In addition, every DMA packet may be monitored. This may lock not only the DMA address register but also all controller registers due to the granularity of stage-2 paging, the minimal size of which is 4 KB. Therefore, we can essentially trap any attempt to configure the controller for URB transmission. Herein, the URB may be an abbreviation for USB Request Block and may be a data structure for exchanging data with USB peripheral devices. URB transmission may refer to sending and receiving data to and from a USB peripheral device through this structure. The URB may contain all the information necessary for a transaction, such as address, endpoint, and buffer address, and using this information, the USB controller may configure and transmit the transaction. There are two types of URB transmission: a data endpoint for transmitting data and a control endpoint for controlling USB peripheral devices. As for the transmission direction, the IN endpoint may transmit data from the peripheral device to the host and the OUT endpoint may transmit data from the host to the peripheral device. The URB transmission may be a key mechanism by which USB controllers exchange data with peripheral devices.

Due to this property, we may additionally implement the trap handler in the hypervisor to monitor the channel configuration as well as the DMA packet and thus enable access control to the LED. Any attempt to write the device (peripheral) address and buffer address to the controller registers for the channel configuration may be monitored. First, the device address can be retrieved from the value written to the channel characteristic register (hcchar). Using this, we may filter out URB for other peripheral devices. In addition, the current channel number can be obtained on the basis of the trapped stage-2 page fault address. Specifically, since each channel has the same memory layout of configuration registers that are placed in the contiguous memory, the current channel number can be obtained on the basis of the offset between the first channel address and the fault address. The setup of buffer address, which is used by the DMA controller, may also incur a stage-2 page fault. The current channel number can be obtained on the basis of the fault address. When the current channel is the channel assigned for the keyboard, we can copy and decode the content of the buffer in the secure (hypervisor) memory. MyTEE may turn on the LED only when the LED control message is found from the decoded content and the trusted keyboard flag is set.

This section may describe the protection of data input from a USB keyboard. The access to the controller registers may be monitored by using the MMIO (Memory Mapped Input/Output) and the device address and channel number may be retrieved as described above. The way of managing the stage-2 paging fault that is incurred by setting up the buffer address for DMA may be different because DMA is used to fetch the scan code. The buffer may be updated by DMA with a fetched scan code. The integrity and confidentiality of the scan code should be protected. To this end, MyTEE may switch and protect with the secure buffer while handling MMIO. By doing so, the untrusted OS cannot access the buffer, but it is still possible to fetch the scan code because the hardware (i.e., DMA controller) can still access the secure buffer.

While handling the interrupt due to completion of DMA, the secure buffer may be accessed to execute a peripheral specific logic such as scan code conversion. Therefore, the escalated privilege may be required to read data from the protected memory. Accordingly, the approach that escalates the privilege of driver code blocks shown in Listing 2 can be adopted. That is, the code blocks that access the secure buffer can be wrapped with mytee_priv_up and mytee_priv_down APIs. For simplicity of implementation, a new function that integrates mandatory and minimal operations for translating and protecting the scan code may be developed. Then, the function may be wrapped in its entirety using the MyTEE APIs instead of wrapping the scattered code blocks in the kernel that access the secure buffer. In the function, the scan code may be converted to the key code and the key code may be written to the secure memory for future use by the TA.

For reference, additional operations can be performed by the device driver in addition to the translation of key code. For example, when the keyboard supports volume control keys, the driver can notify a key-press event to another (e.g., speaker) device driver. The unprivileged part of the driver may be allowed to continue to conduct such tasks in our example implementation. In addition, when the key event occurs, it may not be directly handled in the TEE. Instead, the operating system and device driver instrumented with MyTEE may handle the task. Specifically, each key event may be processed in the REE until the CA finishes collecting user input. Then, the key codes stacked in the secure memory may be handled by the TA. Our approach may have clear advantages over directly handling the interrupt in the TEE. This is because additional changes to the operating system and TEE are required for forwarding and handling interrupts to the TEE, and complicate system design and bloat the TEE.

Tracking device address. For example, the device address should be kept updated for reliable peripheral identification. To this end, two standard control messages may be monitored: GET_DESCRIPTOR and SET_ADDRESS. USB devices may have a default device address of 0x0 when first connected to the USB port. The operating system may send a URB with the GET_DESCRIPTOR to get the information such as USB class and protocol of the device. MyTEE may hook this to detect the keyboard connection. Then, the URB with the SET_ADDRESS may be monitored to assign a new address for the device.

### C. Trusted Display

In this section, how MyTEE protects the framebuffer for trusted displays may be demonstrated. On Raspberry Pi, the video core (i.e., GPU) may manage configuration of the display, such as the framebuffer allocation and display resolution setup. The OS can send a request for the display configuration to the video core. The inter-processor communication between the CPU and the video core may be conducted through the Mailbox controller. Any request or response may be exchanged by performing MMIO to the Mailbox controller registers.

For secure IO, first the display configuration may be guaranteed not to be maliciously changed. For this, the memory-mapped registers of the Mailbox controller may be locked by leveraging stage-2 paging. The mytee_shield_mmio may be invoked in the ioctl handler for display configuration (i.e., FBIOPUT_VSCREENINFO) in the pDrv. In addition, the cDrv of Mailbox controller may be patched in a similar fashion as shown in Listing 2 to enable access to the shielded registers under MyTEE supervision. To prevent TOCTTOU attacks, the display configuration may be restricted to be performed only once after the Mailbox controller registers are locked. The validity of configuration may be checked against the TA's original request right before updating the framebuffer. In general, there are two interfaces for manipulating the framebuffer: write and mmap. MyTEE may support both mechanisms to realize the trusted output as follows.

mmap-based access. The pDrv generally may provide the mmap mechanism to enable the user application to directly access the framebuffer. In order to implement secure IO, a privileged block with MyTEE APIs may be placed at the end of the mmap handler in the pDrv. When the proxy CA maps the framebuffer to handle the mmap request from the TA, the patched mmap handler may be triggered. The physical address of the framebuffer may be obtained as part of general mmap handling process. Then, the privileged block may validate the address and size for mmap to prevent any of the MyTEE protected regions from being maliciously mapped to the TA (e.g., Boomerang attack). In addition, the valid region may be shielded and the corresponding (physical) address and size may be written to the secure memory. Subsequently, the TA may verify the controller and framebuffer-related logs and may ask the TEE OS to directly map the framebuffer to its address space by referring to the information in the secure memory.

Write system call. The write handler in the pDrv may support directly writing data to the framebuffer. Enabling this in secure IO may require the system to ensure that the written data cannot be leaked or manipulated. To this end, the TA may first place the secret data in the secure memory and may ask the CA to invoke the write system call with dummy data. Similar to the mmap-based approach, the write handler of the pDrv may be instrumented to entail the privileged code block that shields the framebuffer and validates the memory operations. Next, the secret data may be copied from the secure memory to the shielded framebuffer. Since the task of updating the framebuffer is delegated to the instrumented device driver (unlike in the mmap support), the log verification may be performed in the privileged block. In addition, an indicator for successful establishment of a secure IO channel may be implemented for both approaches.

TABLE 3
Trusted component

| Monitor* | Hypervisor | Kernel* |
|---|---|---|
| 517 + 1492 (ASM) | 1552 (ASM) | 673 |

Secure IO (driver patch + TA)

| TPM | USB keyboard | Framebuffer |
|---|---|---|
| 159 + 516 | 96 + 156 | 168 + 201 |

*Include TZ-RKP adoption

In relation to the implementation, the POC of MyTEE may be implemented on a Raspberry Pi 3 development board equipped with Broadcom BCM2837 SoC. The SoC may be integrated with a quad-core ARM Cortex-A53 processor, DesignWare USB 2.0 controller, DMA controller with 16 channels, and SPI controller. As security features, only the security state of the CPU may be supported, and TrustZone extensions such as TZPC, TZASC, TZMA may not be supported. The OP-TEE and Linux (ver. 4.14) may be deployed for the TEE and REE software platforms, respectively. Table 3 may show the size of trusted components and device driver patches (and TAs) for secure IO. For the TZ-RKP adoption, 673 LOC may be added in the kernel and 821 LOC (ASM) may be added in the monitor. TZ-RKP may stand for TrustZone Root Key Provisioning. It may generate the TrustZone Root Key required to implement a secure boot process using TrustZone, and using this, may build a Trusted Execution Environment (TEE), a region safely protected from attacks.

### A. ARM Trusted Firmware

The ARM trusted firmware may be updated to create the stage-2 page tables for isolating TEE and hypervisor from the untrusted OS. Specifically, the memory region, for security-critical objects (e.g., hypervisor stack, secure buffer) including the hypervisor stack and security buffers, and the tables themselves may be mapped in the stage-2 translation layer. Runtime management of the stage-2 page tables for shielding the MMIO region of controllers on demand may be performed in the monitor mode (i.e., BL31 of ARM trusted firmware). In addition, the emulation of critical kernel operations such as the update of page tables and system registers may be conducted in the monitor mode as well.

### B. OS Kernel and Drivers

The kernel page table may be shared with the hypervisor. Thus, the page table format and virtual address range supported by the kernel and hypervisor should be equivalent. When 64-bit virtual addresses are used, the virtual address range supported by the hypervisor mode may be smaller than that in the 32-bit address mode. In this mode, there are two types of page table descriptor formats: short descriptors and long descriptors. However, the hypervisor mode may only support the long descriptor format. Thus, the kernel may be compiled as a 32-bit binary with the large physical address extension option (i.e., CONFIG_ARM_LPAE in the .config file) so that the kernel also uses the long descriptor format.

Once the kernel text, data, and hypervisor are loaded in the memory, they may be protected by stage-2 paging. The shielding request may be generated by the init process that is instrumented to invoke the MyTEE. Critical operations, such as the page table update, may be patched with the SMC for the verification and emulation by MyTEE. In order to locate such critical operations in the kernel source, Samsung open-source project may be referred, which provides the kernel patch for TZ-RKP implementation.

TABLE 4

| System register | Description |
|---|---|
| SCTLR | Controls MMU, instruction alignment, etc. |
| TTBRx | Sets the base address of page tables |
| TTBCR | Configures memory translation attributes |
| DACR | Defines access permissions for memory domains |

Table 4 may list the critical system registers that are dynamically reconfigured in the kernel at runtime, thereby resulting in each configuration being emulated instead of simply being removed. For example, TTBR0 may be set at context switches and SCTLR may be configured to activate the memory alignment trap at every kernel entry from user mode.

### C. Hypervisor

The tiny hypervisor may be implemented in ASM from scratch. For the page table sharing, the translation table base register (HTTBR) may be configured with the same value in the translation table base register (TTBR1) that contains the kernel page table address. This configuration may be conducted at boot time and the instruction for setting HTTBR may be nullified to ensure that it is not abused by the attacker. The hypercall handler may be implemented to support MyTEE APIs such as mytee_priv_up. The context of the kernel may be stored in the saved program status register (SPSR) when the hypercall is invoked. In general, the saved context may be restored by using the eret instruction when returning to kernel. Instead, we may use the ret instruction to return to kernel without deprivileging so that the chosen (wrapped) blocks of device drivers run with the hypervisor privilege. The watchpoint-based DMA register protection may not be implemented in the 32-bit hypervisor. This is because configuring watchpoints for the 32-bit hypervisor is not supported in the ARM architecture.

### D. OP-TEE

Some OS-level services need to be supported for the TA implementation. For example, the page table mapping to the secure memory in the hypervisor region may need to be created to enable the TA to access the secure buffers. To this end, OP-TEE APIs may be leveraged instead of adding. On the other hand, the peripheral specific logic necessary to build secure IO, such as TPM command generation and log verification, may be implemented in the TA. A GitHub branch for OP-TEE that supports Raspberry Pi OS (i.e., Raspbian) may be used.

In relation to SECURITY ANALYSIS, race condition attack. MyTEE may log operations in the privileged blocks and may enable the TA to verify them later. However, since the APIs can be arbitrarily invoked by the untrusted OS, TOCTOU attacks can be used to reduce or eliminate the effectiveness of log verification. TOCTOU may be an abbreviation for Time-of-Check to Time-of-Use, and may be a race condition attack that occurs in security-vulnerable code. This attack may occur when there is a time difference between when the vulnerable code is executed and when its result is used. Using this, an attacker can attempt an attack such as changing the code execution result or obtaining an unexpected result.

For example, an untrusted OS can attempt to lead the TPM to overwrite a random number requested by the TA with a known hash value right after the TA verifies the TPM command log. To remove this race condition, the transaction flag may be maintained and the transaction completed before a new command is delivered to the TPM may be verified. In the trusted display example, a similar race condition attack can be conducted by allowing multiple cores to write to the same shielded framebuffer. However, in the privileged block, the source of the write operation to the framebuffer may be always fixed to the secure buffer that only can be updated by the TA, so exploiting the race condition may not be beneficial for the untrusted OS.

Abusing MyTEE APIs. The privilege escalation primitive can be abused to undermine the security of TEE as well as MyTEE itself. Since the TEE is not mapped in the shared page table, the privilege-escalated malicious code cannot directly access the TEE. In addition, the page table may be set to be read-only, preventing its manipulation. However, the attacker can attempt to update the page table base register (i.e., HTTBR, VTTBR) with a malicious page table that has a mapping to the TEE. Thus, we may nullify critical instructions that configure the system registers at boot time. In addition, the mytee_priv_up API may be guaranteed to be executed within the static kernel text, not in the dynamically loaded modules (e.g., LKMs). The privileged memory operation can also be abused. To prevent this, the memory operation may be verified with the context information of the target peripheral device, so that the memory operation is performed within the predefined regions of controller registers and secure buffers.

Exploiting vulnerabilities. The privileged code block may be small enough to be formally verified. Even when the attacker hijacks the control flow by exploiting the vulnerability in the privileged block, the TEE may be still secure because no critical instructions, such as those for configuring the HTTBR, exist in the executable region. In addition, any illegitimate writing to the DMA controller registers may be monitored by leveraging the watchpoint-based memory protection. In the case of attacks in collusion with dynamically loaded kernel modules, additional security facilities for privilege escalation can be added to prevent this. For example, the mapping to all the executable regions other than the static kernel text may be removed when the privilege is escalated. This may be left for future work.

In relation to performance evaluation, adopting MyTEE may impose overhead to the OS, due to the stage-2 paging for memory isolation and filtering DMA packets. In order to measure this overhead, the overhead may be measured by running LMBench and CoreMark-PRO. In addition, the performance of DMA and three secure IO examples with TPM, USB keyboard, and framebuffer may be measured.

### A. LMBench

LMBench may be a benchmark tool used to measure the rudimentary operations of an OS. For example, it can measure memory allocation and freeing, file opening and closing, process creation, and the like. This may allow to measure the time it takes to perform basic operations of the operating system.

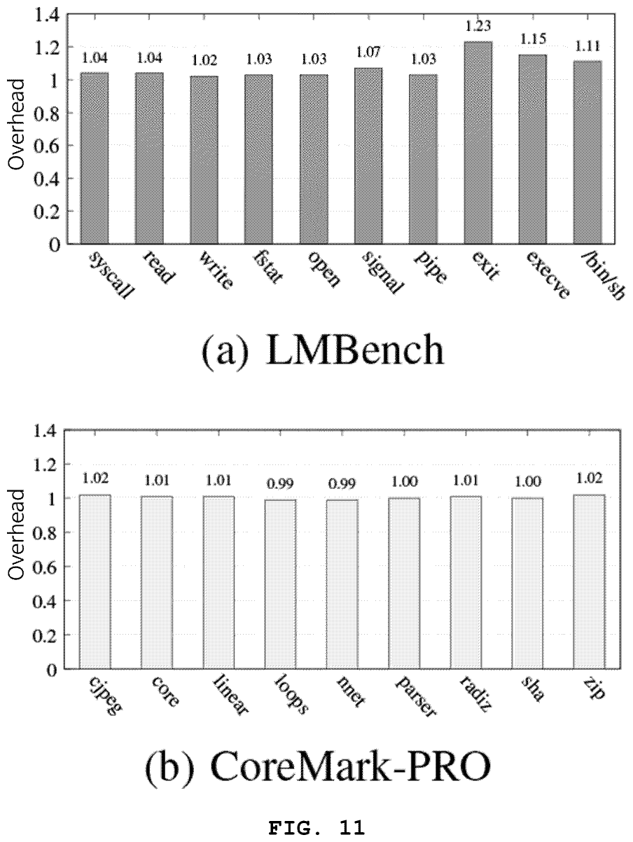

FIGS. 11a and 11b are views showing a result of executing LMBench and CoreMark-PRO. As shown in FIGS. 11a and 11b, when normalizing the LMBench and CoreMark-PRO results of MyTEE compared to Linux, the maximum overhead of up to 23% may be observed in exit.

In the present exemplary embodiment, LMBench may be executed to measure the rudimentary operations of an OS. FIG. 11a may show the average latency of 10 iterations of the tests in LMBench. A minimum overhead of 2% and a maximum overhead of 23% may be observed for write and exit, respectively. execve and /bin/sh also may result in relatively high overhead of 15% and 11%. These high overheads may be incurred due to not only enabling the stage-2 paging but also the emulation of critical operations, which are performed in the monitor mode. Specifically, exit, execve, and /bin/sh may generate more page faults to fork a new process and more context switches due to relatively longer execution times. Therefore, more overhead for switching CPU modes and emulating the critical operations may be imposed.

### B. CoreMark-PRO

CoreMark-PRO may be one of the benchmarks for measuring the performance of processors and memory subsystems. The CoreMark-PRO benchmark may support five integer and four floating point workloads to measure the performance of the processor and memory subsystem. In the present exemplary embodiment, each workload may be executed 10 times and the average latency may be evaluated. As shown in FIG. 11b, the observed overhead may be negligible. Most tests may be observed with overheads of 1 to 2%. Considering the fact that the average runtime of CoreMark-PRO tests is much longer than that of LMBench, the overhead may be somewhat obscured when the overall runtime increases beyond a certain amount of time.

### C. DMA Performance

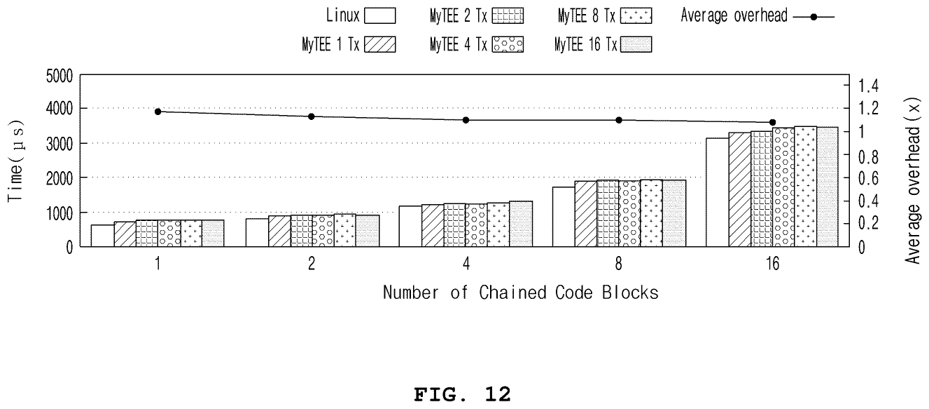

The overhead imposed by DMA filtering may be evaluated by measuring the time for configuring the DMA controller, which is trapped, verified, and emulated by MyTEE. Specifically, CBS (control blocks) that program the DMA controller to perform memory-to-memory data transmission in TD mode may be created. The number of chained CBs and the number of transmissions defined by a single CB may be ranged from 1 to 16. FIG. 12 is a view showing a performance of a memory-to-memory data transmission in a DMA TD mode when CB is verified by MyTEE. The verification overhead of CBs may be reduced to 8% as the number of connected CBs increases.

This time may include the latency for preparing the CBs (e.g., allocating non-cacheable memory) as well as the MMIO with the controller. The performance impact of the number of transmissions by each CB may be negligible. However, the average overhead may decrease from 17% to 8% as the number of CBs increases. According to our analysis, this is because the time for MyTEE verification (that is, copying CBs and verifying the expected memory access) is smaller than that for creating CBs so that the overhead gradually decreases with the larger number of chained CBs.

### D. Trusted Applications

1) Hardware TPM: In the present exemplary embodiment, the overhead imposed on TPM resulting from the adoption of MyTEE may be evaluated. Among the TPM operations, the latency of random number generation and hashing using the SHA256 and SHA1 algorithms may be measured specifically. Herein, SHA256 and SHA1 may be one of the hash functions. A hash function may be an algorithm that converts data of arbitrary size into data of fixed size. This converted data may be also called a hash value or message digest. SHA256 may generate a hash value of 256 bits (32 bytes), and SHA1 may generate a hash value of 160 bits (20 bytes). These hash functions may be mainly used for data integrity verification, message authentication, digital signatures, and the like.

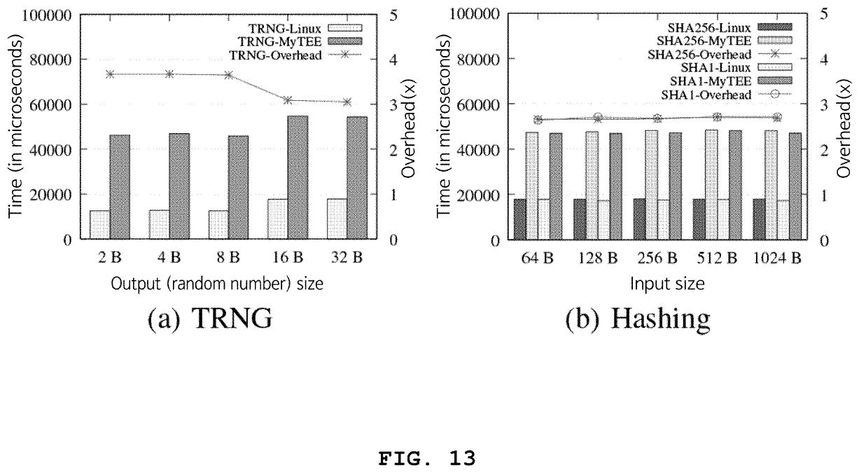

The size of the random number generated by the TPM may range from 2 to 32 bytes. For hashing, the input size may vary from 64 to 1024 bytes. Each TPM operation may be performed 10 times, and the average delay time may be illustrated in FIGS. 13a and 13b.

FIGS. 13a and 13b are views showing a performance (microseconds) of a hardware TPM for a random number generation and a hashing with SHA1 and SHA256. A performance degradation of 3.68 times may be observed with the generation of a 2-byte random number. However, the performance may be slightly improved as the output size increases.

On the other hand, the performance degradation by maximum 2.71 times may be observed in hashing. The overhead may be incurred due to additional privileged operations in device drivers such as logging TPM commands and protecting TPM output and the latency for communication between the CA and TA may be also included in the overhead. In the case of random number generation, a tendency may be observed wherein the overhead slightly decreases as the size of the random number increases. This may stem from the fact that the overhead imposed by MyTEE is almost invariable, whereas the time taken by TPM for the random number generation is generally affected by the size of the random number. By contrast, since the impact of input size is negligible in the hash operation of TPM, a nearly invariable overhead may be observed regardless of input size.
2) Framebuffer: The overhead of framebuffer protection may be evaluated. To this end, we may compare the performance of writing data, the size of which ranges from 1.6 MB to 6.4 MB, to the shielded framebuffer and the non-shielded framebuffer.

This time, the overhead of the framebuffer protection may be evaluated. To this end, the performances of the works of sequentially writing data of different sizes from 1.6 MB to 6.4 MB to the non-shielded framebuffer and the shielded framebuffer may be compared. Both mmap-based and write-based methods may be evaluated.

TABLE 5

| Input | 1.6 MB | | 3.2 MB | | 6.4 MB | |
|---|---|---|---|---|---|---|
| size | Baseline | MyTEE | Baseline | MyTEE | Baseline | MyTEE |
| write | 51.80 | 59.02 (1.14×) | 93.97 | 64.46 (0.68×) | 149.63 | 93.32 (0.62×) |
| mmap | 56.44 | 44.06 (0.78×) | 97.15 | 63.64 (0.66×) | 143.10 | 75.63 (0.53×) |

Table 5 may show the average latency of 10 runs of each test and the resulting overhead. 14% overhead in writing 1.6 MB data may be observed with the write-based approach. However, the performance may be improved when writing larger data. The overheads of 32% and 38% may be observed with 3.2 MB and 6.4 MB data, respectively. With the mmap-based approach, writing to the shielded framebuffer may outperform in all test cases. Specifically, the performance improvement of 47% may be observed when 6.4 MB data is written to the framebuffer with mmap. According to the analysis result, the performance may be improved due to the settings for the privilege escalation of the code block that accesses the shielded framebuffer. That is, since the interrupt is disabled in the privileged block, the write operation can be atomically performed. On the other hand, in baseline, several context switches may occur during the write and the time consumed for the switches may be large enough to obscure the overhead of MyTEE.
3) USB Keyboard: The performance of the protected USB keyboard may be evaluated in two aspects: (1) overhead of handling a single key stroke in kernel and (2) performance of an application that generates secure key inputs. One cycle of handling a key input in kernel may be composed of two phases: sending a URB to read the scan code from the keyboard via DMA and handling the interrupt that is raised by the completion of the DMA. The performance of these two phases may be separately measured and the average latency of 10 runs for each phase is shown in Table 6.

TABLE 6

| Kernel | | Secure key input | | | |
|---|---|---|---|---|---|
| service (in (μs.) | | application (in sec.) | | | |
| URB trans. | IRQ handling | 125^{†} | 250^{†} | 500^{†} | 1000^{†} |
| 94.2 (3.05x) | 64.7 (1.33x) | 2.8 (1.05x) | 6.8 (1.08x) | 14.1 (1.09x) | 28.8 (1.07x) |

^{†}# of virtual key inputs

For sending a URB, approximately 3 times the amount of time may be required due to the adoption of MyTEE. In particular, the overhead may be incurred by handling stage-2 paging faults to access the shielded MMIO region. As described in Section VI-B2, the faults may be monitored to track the currently assigned channel and to configure a secure buffer as the DMA destination. The performance of interrupt handling may be evaluated by measuring the execution time of hid_irq_in function. This function may define several branches for handling URBs depending on the status fields. The status field may indicate whether the sent URB is successfully processed, or whether an error is encountered.

The time for handling a successful URB, the urb->status field of which is cleared, may be measured and the overhead of 33% may be observed. The new function that translates scan code and is wrapped as a privileged code block may be the main cause of the overhead.

In the application benchmark, multiple key inputs between 125 and 1000 may be virtually generated, 10 ms delay may be added between each key input and the same number of characters may be written to the framebuffer. The overhead of the application may be between 5% and 9%. The overhead may be reasonable in general secure IO scenarios in that the input size is even smaller (e.g., passcode, OTP), and human input speed is slower and more variable compared to virtual key inputs and thus causes more factors (e.g., interrupt) to obscure the overhead.

1. A system for implementing a software-based trusted execution environment for an embedded device, the system comprising:
a stage-2 paging unit for separating a software-based trusted execution environment (TEE) and a rich execution environment (REE) of an embedded device to independently manage a memory in each execution environment;
a DMA filtering unit for filtering a DMA transaction that directly transmits data from an input/output (I/O) device to a memory in order to defend against a malicious DMA attack;
a memory isolation and protection unit for isolating a TEE and REE, a hypervisor, and a security monitor;
a temporary authority escalation/de-escalation unit for escalating or de-escalating a privilege in order to temporarily use a resource provided in the rich execution environment when performing security-related tasks in the trusted execution environment; and
a security input/output unit for performing a logging and a verification of an input and output operation between the TEE and the REE.

2. The system of claim 1, wherein the memory isolation and protection unit compensates for an absence of a memory isolation hardware (TZASC) by achieving a memory isolation on the basis of a stage-2 paging of a virtualization technology.

3. The system of claim 1, wherein the temporary authority escalation/de-escalation unit compensates for an absence of a secure input/output hardware (TZPC) by reusing a device driver to temporarily escalating or de-escalating the privilege in a code block of an input/output operation.

4. A method using a system for implementing a software-based trusted execution environment for an embedded device, the method comprising:
(a) separating a software-based trusted execution environment (TEE) and a rich execution environment (REE) of an embedded device to independently manage a memory in each execution environment by the system;
(b) filtering a DMA transaction that directly transmits data from an input/output (I/O) device to a memory by the system;
(c) isolating TEE and REE, a hypervisor, and a security monitor by the system;
(d) escalating or de-escalating a privilege in order to temporarily use a resource provided in the rich execution environment when performing security-related tasks in the trusted execution environment by the system; and
(e) performing a logging and a verification of an input and output operation between the TEE and the REE by the system.
